(19) United States
(12) Patent Application Publication
(10) Pub. No.: US 2026/0193110 A1
(43) Pub. Date: Jul. 9, 2026

(54) INTERSTAGE BRINE DILUTION IN REVERSE OSMOSIS (RO) PLANTS

(71) Applicant: ACWA POWER Company, Riyadh (SA)

(72) Inventors: Justin Robert Paden Justin PALACE, Dubai (AE); Ahmed Yousry Ahmed MAHMOUD, Dubai (AE); Hassan Abdulaziz ALMSAEED, Dubai (AE); Hariharan ELAIYAPERUMAL, Riyadh (SA); Tariq Nabil NADA, Jeddah (SA)

(73) Assignee: ACWA POWER Company, Riyadh (SA)

(21) Appl. No.: 19/012,678

(22) Filed: Jan. 7, 2025

(51) Int. Cl. C02F 1/44; C02F 103/08

(52) U.S. Cl. CPC C02F 1/441; C02F 2103/08; C02F 2209/40; C02F 2301/08; C02F 2303/10

(57) ABSTRACT

An apparatus and method for interstage brine dilution in reverse osmosis (RO) plants. The apparatus controls a first RO stage to supply a first brine stream to a second RO stage. The apparatus controls the second RO stage to generate at least a second brine stream based on the supplied first brine stream. The apparatus controls the second RO stage to supply the second brine stream to an energy recovery unit. The apparatus controls the energy recovery unit to receive a liquid stream. The apparatus controls the energy recovery unit to supply the liquid stream to the second RO stage based on the second brine stream. The supplied liquid stream is blended with the first brine stream to generate a second diluted stream. The apparatus further controls the second RO stage to generate at least the second brine stream based on the second diluted stream.

### TECHNICAL FIELD

The present disclosure generally relates to water treatment and more particularly relates to interstage brine dilution in reverse osmosis plants.

### BACKGROUND

In recent years, the problem of water shortage has increased on a global level. Owing to a shortage of freshwater, seawater may be filtered to make it fit for human consumption. Desalination, a process of removing salts and other impurities from seawater to produce fresh or potable water, has emerged as a vital solution to address the challenge of water shortage. Conventional desalination techniques primarily include thermal distillation and membrane-based processes, such as reverse osmosis (RO) process.

The RO process has become the predominant desalination technology due to its higher energy efficiency compared to thermal methods. However, RO-based desalination systems still face several challenges. One such challenge is high energy consumption. The presence of high total dissolved solids (TDS) in the seawater requires high energy consumption to filter the seawater. The high energy consumption to filter the seawater may decrease the energy efficiency of the RO systems. To meet the energy demands, the RO often relies on non-renewable energy sources to meet energy demands.

In conventional RO systems, the high total dissolved solids (TDS) levels between two RO stages necessitate the use of high pressure to meet the feed pressure requirements of the subsequent stage. This results in increased energy consumption and operational costs. Therefore, there is a need to overcome the challenges associated with the RO systems having high energy consumption.

### SUMMARY

In comparison with the traditional techniques, the present disclosure provides a reverse osmosis (RO) desalination apparatus for the RO process to produce freshwater that allows reduced energy utilization thereby reducing the operational cost of the desalination process.

It is an objective of the disclosure to provide an improved RO desalination apparatus to produce freshwater or potable water. The improved RO desalination apparatus enables to achieve reduced specific energy consumption (SEC) in RO desalination. The apparatus may reduce the power consumption for the RO desalination and may enhance energy efficiency.

The disclosure proposes a method for the interstage dilution of brine stream in an RO plant (also referred to as RO system). In conventional RO systems, the high TDS levels between two RO stages necessitate the use of high pressure to meet the feed pressure requirements of the subsequent stage. This results in increased energy consumption and operational costs. The high-pressure output from the energy recovery device (ERD) is usually fed upstream of the first stage, which does not address the need for pressure adjustments between stages. The disclosure proposes a method for the interstage dilution of brine stream in an RO plant. The outstream from the ERD is blended with the brine of an RO stage to dilute its concentration. This dilution by blending reduces the total dissolved solids (TDS) concentration of the brine, thereby lowering the pressure required at the feed of the next stage. By varying the recoveries of both stages to match the brine pressure of the previous stage with the feed pressure of the next stage, the need for an interstage booster pump can be eliminated.

In one aspect, an apparatus for interstage brine dilution in RO plants is provided. The apparatus includes one or more processors configured to control a first RO stage to supply a first brine stream to a second RO stage. The one or more processors are further configured to control the second RO stage to generate at least a second brine stream based on the supplied first brine stream. The one or more processors are further configured to control the second RO stage to supply the second brine stream to a third RO stage. The one or more processors are further configured to control, at a first time period, the third RO stage to generate at least a third brine stream based on the second brine stream. The one or more processors are further configured to control the third RO stage to supply the third brine stream to an energy recovery unit. The one or more processors are further configured to control the energy recovery unit to receive the third brine stream from the third RO stage. The one or more processors are further configured to control, at a second time period, the energy recovery unit to receive a liquid stream. The liquid stream is at a first pressure value. The liquid stream corresponds to at least a seawater. The one or more processors are further configured to control the energy recovery unit to supply the liquid stream to the third RO stage. The supplied liquid stream is supplied at a second pressure value based on the third brine stream from the third RO stage. The one or more processors are further configured to control the third RO stage to generate at least the third brine stream based on a first diluted stream. The first diluted stream corresponds to a mixture of the second brine stream and the liquid stream.

In an embodiment, one or more processors are further configured to control the energy recovery unit to supply the liquid stream to the second RO stage. The liquid stream is supplied at the second pressure value based on the third brine stream from the third RO stage. Further, the one or more processors are configured to control the second RO stage to generate at least the second brine stream based on a second diluted stream. The second diluted stream corresponds to a mixture of the first brine stream and the liquid stream from the energy recovery unit.

In an embodiment, the one or more processors are further configured to control the energy recovery unit to supply the liquid stream to the second RO stage. The supplied liquid stream is supplied at the second pressure value based on the second brine stream from the second RO stage. The one or more processors are further configured to control the second RO stage to generate at least the second brine stream based on the second diluted stream.

In an embodiment, the one or more processors are further configured to control the first RO stage to execute an RO operation on the liquid stream. The one or more processors are further configured to control the first RO stage to generate at least a first permeate stream and the first brine stream upon the execution of the RO operation on the liquid stream.

In an embodiment, the one or more processors are further configured to control the second RO stage to execute the RO operation on the first brine stream. The one or more processors are further configured to control the second RO stage to generate at least a second permeate stream and the second brine stream upon the execution of the RO operation.

In an embodiment, the one or more processors are further configured to control the third RO stage to execute the RO operation on the first diluted stream. The one or more processors are further configured to control the third RO stage to generate at least a third permeate stream and the third brine stream upon the execution of the RO operation.

In an embodiment, the one or more processors are further configured to control the supply of at least one of the first permeate stream, the second permeate stream, and the third permeate stream to generate a blended permeate stream.

In an embodiment, a first total dissolved solids (TDS) value associated with the first brine stream is less than a second TDS value associated with the second brine stream.

In another aspect, a method for the interstage brine dilution in the RO plants is provided. The method includes controlling a first RO stage to supply a first brine stream to a second RO stage. The method further includes controlling the second RO stage to generate at least a second brine stream based on the supplied first brine stream. The method further includes controlling the second RO stage to supply the second brine stream to a third RO stage. The method further includes controlling, at a first time period, the third RO stage to generate at least a third brine stream based on the second brine stream. The method further includes controlling the third RO stage to supply the third brine stream to an energy recovery unit. The method further includes controlling the energy recovery unit to receive the third brine stream from the third RO stage. The method further includes controlling, at a second time period, the energy recovery unit to receive a liquid stream. The liquid stream is at a first pressure value. The liquid stream corresponds to at least a seawater. The method further includes controlling the energy recovery unit to supply the liquid stream to the third RO stage. The supplied liquid stream is supplied at a second pressure value based on the third brine stream from the third RO stage. The method further includes controlling the third RO stage to generate at least the third brine stream based on a first diluted stream. The first diluted stream corresponds to a mixture of the second brine stream and the liquid stream.

In an embodiment, the method further includes controlling the energy recovery unit to supply the liquid stream to the second RO stage. The liquid stream is supplied at the second pressure value based on the third brine stream from the third RO stage. The method further includes controlling the second RO stage to generate at least the second brine stream based on a second diluted stream. The second diluted stream corresponds to a mixture of the first brine stream and the liquid stream from the energy recovery unit.

In an embodiment, the method further includes controlling the energy recovery unit to supply the liquid stream to the second RO stage. The supplied liquid stream is supplied at the second pressure value based on the second brine stream from the second RO stage. The method further includes controlling the second RO stage to generate at least the second brine stream based on the second diluted stream.

In an embodiment, the method further includes controlling the first RO stage to execute an RO operation on the liquid stream. The method further includes controlling the first RO stage to generate at least a first permeate stream and the first brine stream upon the execution of the RO operation on the liquid stream.

In an embodiment, the method further includes controlling the second RO stage to execute the RO operation on the first brine stream. The method further includes controlling the second RO stage to generate at least a second permeate stream and the second brine stream upon the execution of the RO operation.

In an embodiment, the method further includes controlling the third RO stage to execute the RO operation on the first diluted stream. The method further includes controlling the third RO stage to generate at least a third permeate stream and the third brine stream upon the execution of the RO operation.

In an embodiment, the method further includes controlling the supply of at least one of the first permeate stream, the second permeate stream, and the third permeate stream to generate a blended permeate stream.

In an embodiment, a first total dissolved solids (TDS) value associated with the first brine stream is less than a second TDS value associated with the second brine stream.

In yet another aspect, an apparatus for interstage brine dilution in RO plants is provided. The apparatus includes one or more processors configured to control a first reverse osmosis (RO) stage to supply a first brine stream to a second RO stage. The one or more processors are further configured to control, at a first time period, the second RO stage to generate at least a second brine stream based on the supplied first brine stream. The one or more processors are further configured to control the second RO stage to supply the second brine stream to an energy recovery unit. The one or more processors are further configured to control the energy recovery unit to receive the second brine stream from the second RO stage. The one or more processors are further configured to control, at a second time period, the energy recovery unit to receive a liquid stream. The liquid stream is at a first pressure value. The liquid stream corresponds to at least a seawater. The one or more processors are further configured to control the energy recovery unit to supply the liquid stream to the second RO stage. The supplied liquid stream is supplied at a second pressure value based on the second brine stream from the second RO stage. The one or more processors are further configured to control the second RO stage to generate at least the second brine stream based on a second diluted stream. The second diluted stream corresponds to a mixture of the first brine stream and the liquid stream.

In an embodiment, the one or more processors are further configured to control the energy recovery unit to supply the liquid stream to the second RO stage. The liquid stream is supplied at the second pressure value based on the second brine stream from the second RO stage. The one or more processors are further configured to control the second RO stage to generate at least the second brine stream based on a second diluted stream. The second diluted stream corresponds to a mixture of the first brine stream and the liquid stream from the energy recovery unit.

In an embodiment, the one or more processors are further configured to control the energy recovery unit to supply the liquid stream to the second RO stage. The supplied liquid stream is supplied at the second pressure value based on the second brine stream from the second RO stage. The one or more processors are further configured to control the second RO stage to generate at least the second brine stream based on the second diluted stream.

In an embodiment, a first total dissolved solids (TDS) value associated with the first brine stream is less than a second TDS value associated with the second brine stream.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1A illustrates a network environment in which an apparatus for two-stage reverse osmosis (RO) with interstage brine dilution is implemented, in accordance with an embodiment of the disclosure;

FIG. 1B illustrates a network environment in which the apparatus for three-stage RO with interstage brine dilution is implemented, in accordance with an embodiment of the disclosure;

FIG. 2 illustrates a block diagram of the apparatus of FIG. 1A and FIG. 1B, in accordance with an embodiment of the disclosure;

FIG. 3 illustrates exemplary operations for the two-stage RO with the interstage brine dilution, in accordance with an embodiment of the disclosure;

FIG. 4A is a diagram that illustrates an exemplary first implementation of apparatus for two-stage RO with the interstage brine dilution, in accordance with an embodiment of the disclosure;

FIG. 4B is a diagram that illustrates an exemplary second implementation of apparatus for two-stage RO with the interstage brine dilution, in accordance with an embodiment of the disclosure;

FIG. 5 illustrates exemplary operations for the three-stage RO with the interstage brine dilution, in accordance with an embodiment of the disclosure;

FIG. 6A is a diagram that illustrates an exemplary first implementation of apparatus for three-stage RO with the interstage brine dilution, in accordance with an embodiment of the disclosure;

FIG. 6B is a diagram that illustrates an exemplary second implementation of apparatus for three-stage RO with the interstage brine dilution, in accordance with an embodiment of the disclosure;

FIG. 6C is a diagram that illustrates an exemplary third implementation of apparatus for three-stage RO with the interstage brine dilution, in accordance with an embodiment of the disclosure;

FIG. 6D is a diagram that illustrates an exemplary fourth implementation of apparatus for three-stage RO with the interstage brine dilution, in accordance with an embodiment of the disclosure;

FIG. 7 is a flowchart that illustrates an exemplary method for the two-stage RO with the interstage brine dilution, in accordance with an embodiment of the disclosure; and

FIG. 8 is a flowchart that illustrates an exemplary method for the three-stage RO with the interstage brine dilution, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

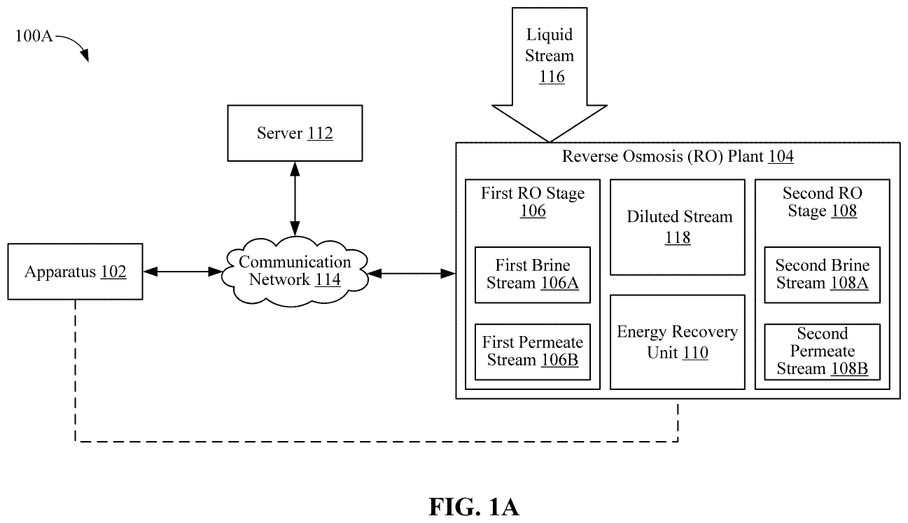

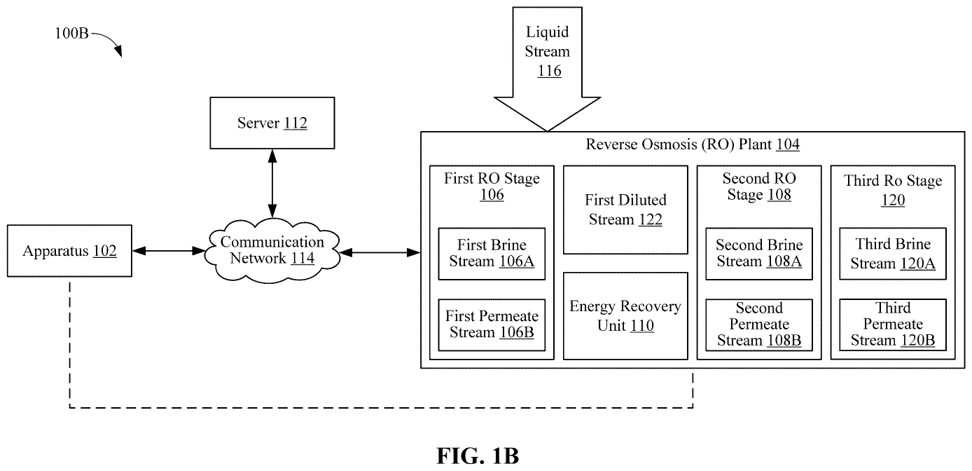

FIG. 1A illustrates a network environment 100A in which an apparatus 102 for two-stage reverse osmosis (RO) with interstage brine dilution is implemented, in accordance with an embodiment of the disclosure. The network environment 100A includes the apparatus 102 which may be used for the two-stage RO with the interstage brine dilution in a RO plant 104. The RO plant 104 may include a first RO stage 106 (also referred to as a first RO unit), a second RO stage 108 (also referred to as a second RO unit), an energy recovery unit 110, and a diluted stream 118 (also referred to as second diluted stream). The first RO stage 106 may generate a first brine stream 106A and a first permeate stream 106B. The second RO stage 108 may generate a second brine stream 108A and a second permeate stream 108B. The network environment 100A may further include a server 112, and a communication network 114. With reference to FIG. 1A, there is further shown a liquid stream 116.

The apparatus 102 may include suitable logic, circuitry, interfaces, and/or code that may be configured to perform one or more operations of the interstage brine dilution in the RO plant 104. The apparatus 102 may be configured to control the first RO stage 106 to receive as input the liquid stream 116 that may be, but is not limited to, a seawater, or a brackish water. The first RO stage 106 may receive the liquid stream 116 from various sources such as, but not limited to, a storage tank, an open inlet, an open seawater intake pipe, or a beach well. In an embodiment, direct consumption of the liquid stream 116 by humans may be unsafe due to its high salt content and therefore RO operations may be required.

The apparatus 102 may be configured to employ RO operation on the liquid stream 116 to produce the first permeate stream 106B and the first brine stream 106A. The RO operation may be a water purification operation that may utilize a set of semi-permeable membranes to filter the impurities, salts, and contaminants (such as sodium, potassium, calcium, and the like) from the liquid stream 116 to generate the first permeate stream 106B. The first permeate stream 106B may be safe for consumption by humans or may be used for downstream purposes (such as human consumption, chemical dilution purposes, steam generation, machinery cooling purposes, and the like). The first brine stream 106A may be a concentrated solution of salts (say sodium chloride) that may be generated as a byproduct of the RO operation on the liquid stream 116. The apparatus 102 may be further configured to remove impurities such as sodium, potassium, calcium, magnesium, and the like from the liquid stream 116 so that the filtered liquid stream 116 (or the first permeate stream 106B) may be fit for human consumption.

In an embodiment, the RO plant 104 may be an industrial facility that may remove salts and other minerals from the seawater to produce freshwater (such as the first permeate stream 106B, or the second permeate stream 108B). The produced freshwater may be suitable for human consumption, irrigation, and other industrial purposes. Further, the RO plant 104 may employ RO operation for the desalination of the seawater. In the case of the RO operation, the seawater may be pressurized and forced through a set of RO membranes that may selectively remove salts and impurities, leaving behind the freshwater. In an embodiment, the RO plant 104 may be, but is not limited to, a seawater RO (SWRO) plant, or a brackish water RO (BWRO) plant.

In an embodiment, the first RO stage 106 may be utilized to filter the liquid stream 116 to remove impurities, salts, and other dissolved minerals (such as sulphates, chlorides, and the like). Further, the first RO stage 106 may be configured to generate the first brine stream 106A and the first permeate stream 106B upon filtering the liquid stream 116 within the first RO stage 106. As discussed above, the first brine stream 106A may be a concentrated solution of salts (say sodium chloride) that may be generated as a byproduct of the RO operation on the liquid stream 116.

The first RO stage 106 (also referred to as the first RO unit) may perform the RO operation on the liquid stream 116. The first RO stage 106 may take as the liquid stream 116. Furthermore, the liquid stream 116 may be filtered by performing the RO operation on the liquid stream 116. In an embodiment, the first RO stage 106 may be designed to process the liquid stream 116 by passing the liquid stream 116 through a set of reverse osmosis (RO) membranes. The first RO stage 106 may further output the first brine stream 106A, i.e., a concentrated solution of salts and other dissolved solids. The first RO stage 106 may further output the first permeate stream 106B, i.e., freshwater or filtered water. The first RO stage 106 may use the set of RO membranes, by way of example and not by limitation, a polyamide membrane, or a cellulose acetate membrane, to separate particles and unwanted dissolved solids from the liquid stream 116.

In an embodiment, the first RO stage 106 may be configured to supply the first brine stream 106A to the second RO stage 108. In an embodiment, the apparatus 102 may be configured to control the second RO stage 108 to receive the first brine stream 106A from the first RO stage 106. The second RO stage 108 may filter the first brine stream 106A to generate the second brine stream 108A and the second permeate stream 108B.

After the generation of the second permeate stream, the first brine stream 106A and the liquid stream 116 may be mixed to product the diluted stream. The diluted stream 118 may be further supplied to the second RO stage 108. In an embodiment, the second RO stage 108 may filter the diluted stream 118 to generate the second brine stream 108A and the second permeate stream 108B.

In an embodiment, the second permeate stream 108B may be the filtered water similar to the first permeate stream 106B. In an embodiment, the first permeate stream 106B, and the second permeate stream 108B may be utilized to generate the blended permeate stream. In an embodiment, the apparatus 102 may be configured to control the supply of the first permeate stream 106B, and the second permeate stream 108B to generate the blended permeate stream. In an embodiment, the blended permeate stream may be supplied to a permeate storage unit, a water processing industrial unit, an irrigation field, and the like.

The energy recovery unit 110 may be a device that may be used to recover and reutilize energy from the high-pressure stream that may be discarded from the RO plant 104. The energy recovery unit 110 may be used to recover and reutilize hydraulic energy from the second brine stream 108A. The recovery and reutilization of the hydraulic energy from the second brine stream 108A may enhance the operational efficiency of the RO plant 104 by transferring the hydraulic energy associated with the second brine stream 108A to the liquid stream 116, thereby optimizing the energy efficiency of the RO plant 104. The utilization of the hydraulic energy associated with the second brine stream 108A to increase the pressure of the liquid stream 116 may lower energy consumption of the RO plant 104 as now less energy may be required by the RO plant 104 to supply the liquid stream 116 (say the liquid stream 116 may be supplied to the second RO stage 108) as compared to the energy required by the RO plant 104 to supply the liquid stream 116 when the hydraulic energy associated with the second brine stream 108A may not be transferred to the liquid stream 116. In an embodiment, the energy recovery unit 110 may capture energy associated with the second brine stream 108A associated with the second RO stage 108. The captured energy from the second brine stream 108A may be further transferred to the liquid stream 116 to increase the pressure of the liquid stream 116. Once the transfer of energy from the high-pressure second brine stream 108A to the liquid stream 116 is complete, the apparatus 102 may control the supply of the diluted stream 118 from the energy recovery unit 110 to the second RO stage 108.

The server 112 may be a specialized machine that may be designed for a specific task within the network environment 100A. The server 112 may play a crucial role in responding to the apparatus 102 request, processing data, and delivering the data efficiently. The server 112 may be designed for high-performance computing and data handling, ensuring that the apparatus 102 requests may be handled accordingly. For example, the server 112 may include but is not limited to, a mail server, a data server, an application server, or a database server.

In an embodiment, a user request may be transmitted to the server 112 to control operations of the RO plant 104. For example, the user request may include instructions such as to trigger an activation of the supply of the liquid stream 116 to the RO plant 104 may be transmitted to the server 112. The server 112 may process the user request to configure the apparatus 102 to control the supply of the liquid stream 116 to the RO plant 104.

The communication network 114 may include a communication medium through which the apparatus 102 may communicate with the server 112. In an embodiment, the communication network 114 may be used to establish a secure connection between the apparatus 102 and the server 112. In an embodiment, the communication network 114 may establish a secure connection between the RO plant 104 and the server 112. The communication network 114 may be one of a wired connection or a wireless connection. Examples of the communication network 114 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100A may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, institute of electrical and electronics engineers (IEEE) 802.11, light fidelity (Li-Fi), 802.16, IEEE 802.11s, IEEE 802.11g, multi-hop communication, wireless access point (AP), a device to device communication, cellular communication protocols, and Bluetooth (BT) communication protocols.

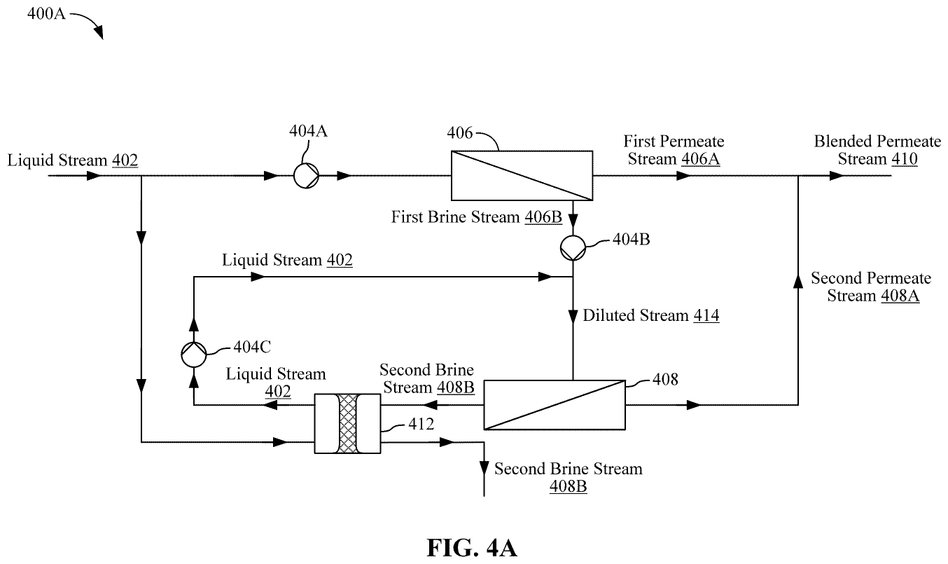

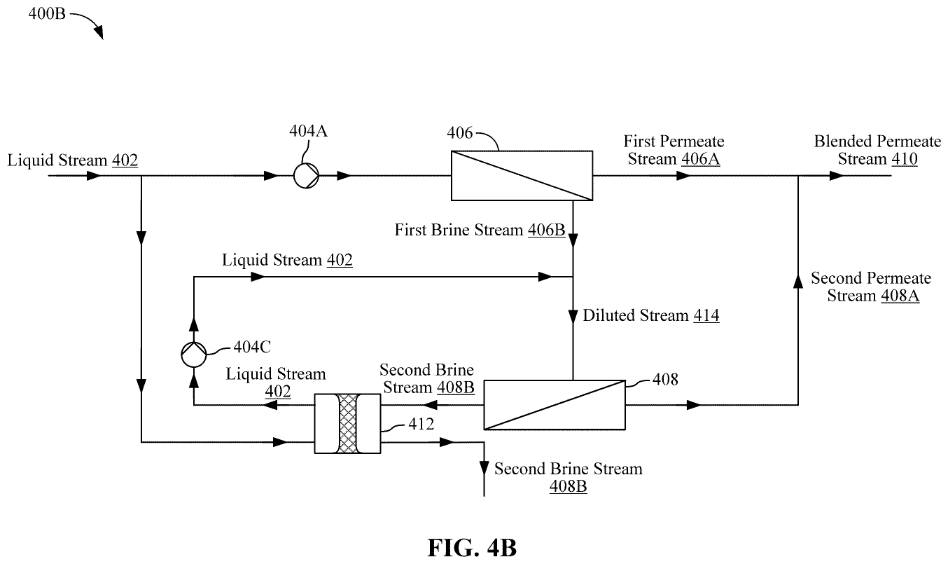

In operation, the apparatus 102 may be configured to control the first RO stage 106 to receive the liquid stream 116. For example, apparatus 102 may be configured to control the first RO stage 106 to receive the liquid stream 116 through a pipeline from a water reservoir (such as a sea, a lake, or a storage unit). In an embodiment, the apparatus 102 may be configured to control the first RO stage 106 to generate at least the first brine stream 106A based on the received liquid stream 116. In an embodiment, the apparatus 102 may be configured to control the first RO stage 106 to supply the first brine stream 106A to the second RO stage 108 at a first time period T1. In an embodiment, the apparatus 102 may be configured to control the first RO stage 106 to supply the first brine stream 106A to the second RO stage 108 without the use of a pressure pump. In an alternate embodiment, the pressure pump may be used to supply the first brine stream 106A to the second RO stage 108 at a pre-determined pressure value. Details about the utilization of pressure pump for the supply of the first brine stream 106A to the second RO stage 108 are provided, in FIGS. 4A and 4B.

In an embodiment, the apparatus 102 may be configured to control the second RO stage 108, at the first time period T1, to generate at least the second brine stream 108A and the second permeate stream 108B based on the supplied first brine stream 106A. The first time period T1 is indicative of the time period associated with the generation of at least the second brine stream 108A and the second permeate stream 108B based on the supplied first brine stream 106A for the first time. The first brine stream 106A is generated based on the liquid stream 116. For example, the apparatus 102 may be configured to control the second RO stage 108 at the first time period to generate the second brine stream 108A. The apparatus 102 may be configured to control the second RO stage 108 to supply the generated second brine stream 108A to the energy recovery unit 110. In an embodiment, the second brine stream 108A may be supplied to the energy recovery unit 110 through the pipeline at a first pre-determined pressure value (say P1).

Further, the apparatus 102 may be configured to control the energy recovery unit 110 to receive the second brine stream 108A from the second RO stage 108 at the first pressure value P1. By way of example and not limitation, the second brine stream 108A received by the energy recovery unit 110, for example, but not limited to, a 30 bar pressure value. In an embodiment, the apparatus 102 may be configured to control the energy recovery unit 110, at a second time period T2, to receive the liquid stream 116. The second time period T2 is indicative of the time period associated with the reception of the liquid stream 116 by the energy recovery unit 110 upon the reception of the second brine stream 108A from the second RO stage 108. The liquid stream 116 may be at a second pressure value say P2. As discussed above, the liquid stream 116 may be at least the seawater, the brackish water, and the like. For example, the apparatus 102 may be configured to control the energy recovery unit 110 at the second time period to receive the liquid stream 116. In an embodiment, the apparatus 102 may be configured to control the energy recovery unit 110 to supply the liquid stream 116 to the second RO stage 108. The supplied liquid stream 116 may be supplied at the second pressure value based on the received second brine stream 108A from the second RO stage 108. For example, the apparatus 102 may be configured to control the energy recovery unit 110 to supply the liquid stream 116 to the second RO stage 108 at the second pressure value using the pressure pump (say the pressure pump is configured to supply the liquid stream 116 to the second RO stage 108 at a 15 bar pressure value). Specifically, the apparatus 102 may be configured to capture the energy from the first brine stream 106A and transfer the captured energy to the liquid stream at the second time period to increase the pressure of the liquid stream 116. Details about using the pressure pump to supply the liquid stream 116 at the second pressure value are provided, in FIG. 4A.

In an embodiment, the liquid stream 116 from the energy recovery unit 110 and the first brine stream 106A from the first RO stage 106 may be mixed to form the diluted stream 118. The diluted stream 118 may be further supplied to the second RO stage 108 (say through the pipeline). In an embodiment, the apparatus 102 may be configured to control the second RO stage 108 to receive the diluted stream 118. The diluted stream 118 may be a mixture of the first brine stream 106A associated with the first RO stage 106 and the liquid stream 116 associated with the energy recovery unit 110. In an embodiment, the apparatus 102 may be configured to control the second RO stage 108 to generate at least the second brine stream 108A and the second permeate stream 108B based on the diluted stream 118.

Although in FIG. 1A, the apparatus 102 is shown as a separate entity from the RO plant 104, the disclosure is not so limited. Accordingly, in some embodiments, the apparatus 102 may be shown integrated within the RO plant 104, without deviation from the scope of the disclosure.

FIG. 1B illustrates a network environment 100B in which the apparatus 102 for three-stage RO with interstage brine dilution is implemented, in accordance with an embodiment of the disclosure. The network environment 100B includes the apparatus 102 which may be used for the three-stage RO with the interstage brine dilution in the RO plant 104. With reference to FIG. 1B, there is further shown the liquid stream 116. The RO plant 104 may include the first RO stage 106, the second RO stage 108, the third RO stage 120, the energy recovery unit 110, a third RO stage 120 (also referred to as a third RO unit), and a first diluted stream 122. The first RO stage 106 may include the first brine stream 106A and the first permeate stream 106B. The second RO stage 108 may include the second brine stream 108A and the second permeate stream 108B. The third RO stage 120 may include a third brine stream 120A and a third permeate stream 120B. The network environment 100B may further include the server 112, and the communication network 114. With reference to FIG. 1B, there is further shown the liquid stream 116.

The functioning of the third RO stage 120 is similar to the functioning of the first RO stage 106. Details about the first RO stage 106 are provided, in FIG. 1A. In an embodiment, the apparatus 102 may be configured to control the third RO stage 120 to generate the third brine stream 120A and the third permeate stream 110B based on the second brine stream 108A.

In an alternate embodiment, the first diluted stream 122 may be generated based on the second brine stream 108A and the liquid stream 116. The first diluted stream 122 may be further supplied to the third RO stage 120. In an embodiment, the third RO stage 120 may filter the first diluted stream 122 to generate the third brine stream 120A and the third permeate stream 120B.

In an embodiment, the third permeate stream 120B may be the filtered water similar to the first permeate stream 106B that may be fit for human consumption. In an embodiment, at least one of the first permeate stream 106B, the second permeate stream 108B, and the third permeate stream 120B may be utilized to generate the blended permeate stream. In an embodiment, the blended permeate stream may be supplied to the permeate storage unit, the water processing industrial unit, the irrigation field, and the like.

In an embodiment, the first diluted stream 122 may be a mixture of the liquid stream 116 and the second brine stream 108A. For example, the apparatus 102 may be configured to control the energy recovery unit 110 to supply the first diluted stream 122 to the second RO stage 108. In an alternate embodiment, the first diluted stream 122 may be a mixture of the first brine stream 106A and the liquid stream 116. For example, the apparatus 102 may be configured to control the energy recovery unit 110 to supply the first diluted stream 122 to the second RO stage 108.

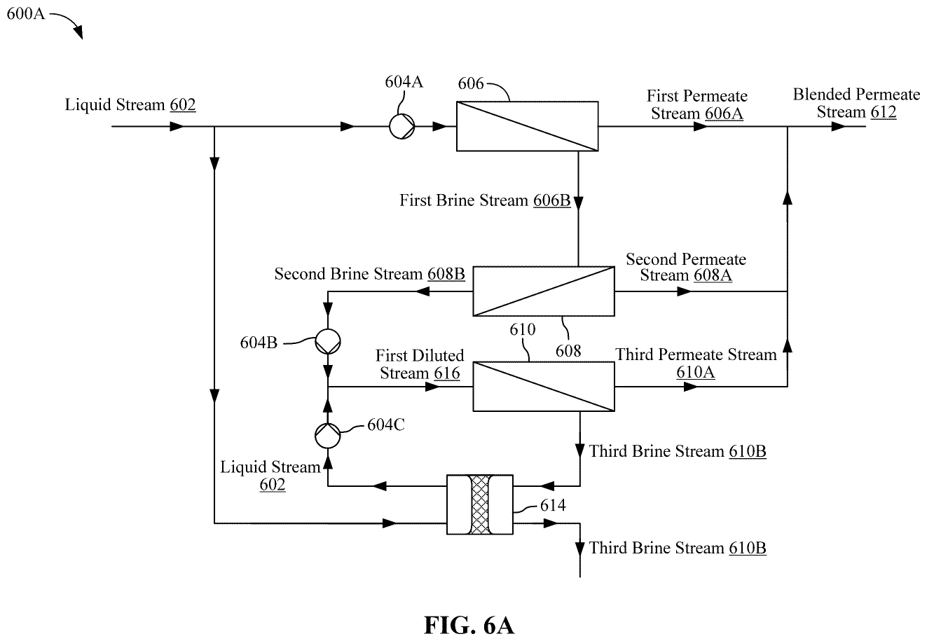

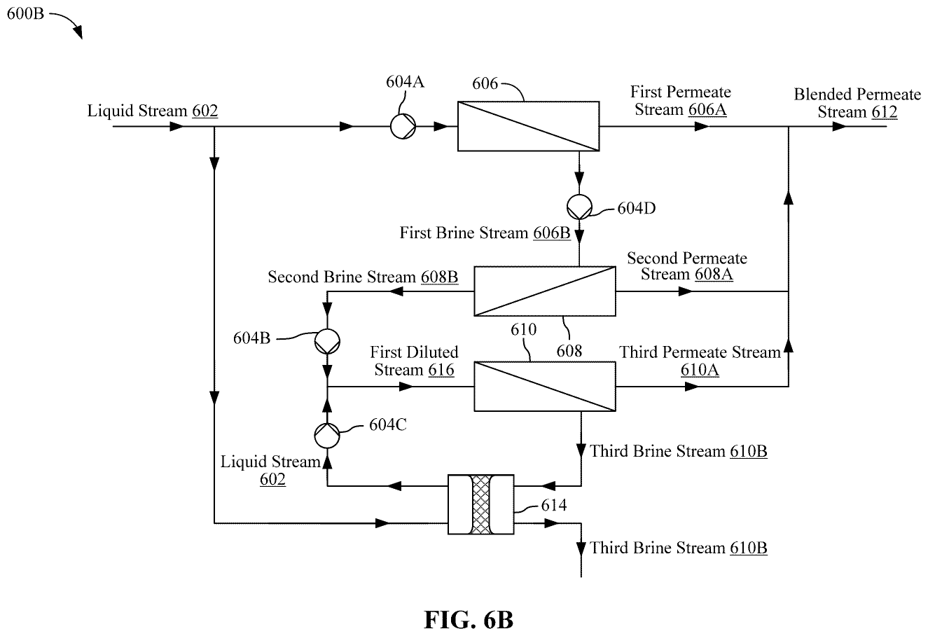

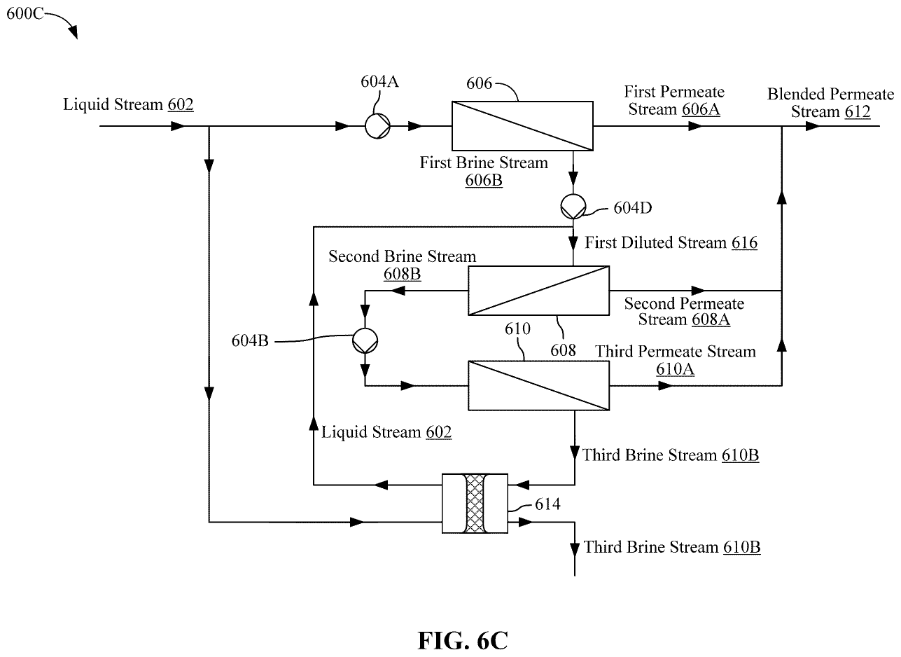

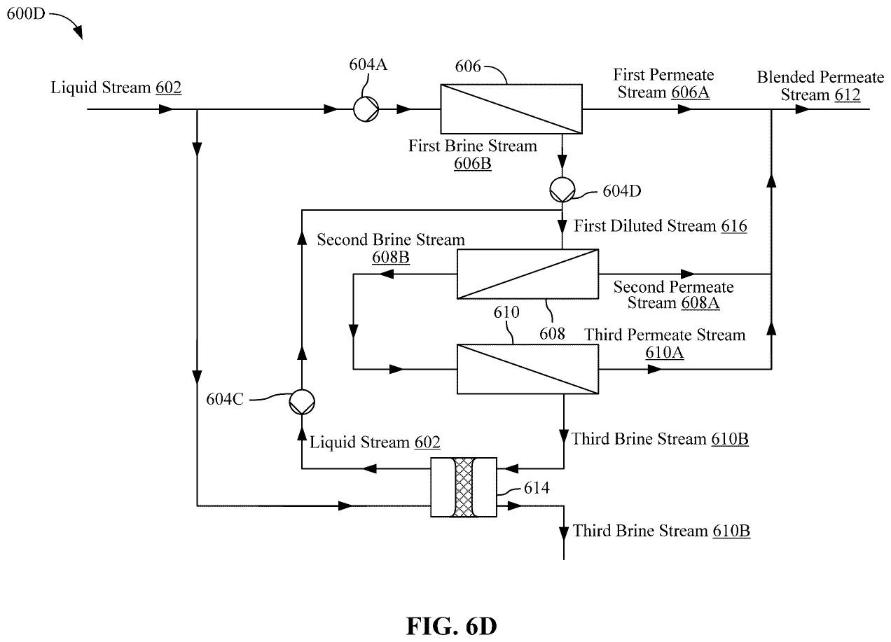

In operation, the apparatus 102 may be configured to control the first RO stage 106 to receive the liquid stream 116. For example, the apparatus 102 may be configured to control the first RO stage 106 to receive the liquid stream 116 through the pipeline from the water reservoir (such as groundwater). In an embodiment, the apparatus 102 may be configured to control the first RO stage 106 to generate at least the first brine stream 106A based on the received liquid stream 116. In an embodiment, the apparatus 102 may be configured to control the first RO stage 106 to supply the first brine stream 106A to the second RO stage 108. For example, the apparatus 102 may be configured to control the first RO stage 106 to supply the first brine stream 106A to the second RO stage 108 through the pipeline at a pressure of 20 bar. In an embodiment, the apparatus 102 may be configured to control the first RO stage 106 to supply the first brine stream 106A to the second RO stage 108 without the use of the pressure pump. In an embodiment, the pressure pump may be used to supply the first brine stream 106A to the second RO stage 108 at the pre-determined pressure value. Details about the utilization of pressure pump for the supply of the first brine stream 106A to the second RO stage 108 are provided, in FIGS. 6A-6D.

In an embodiment, the apparatus 102 may be configured to control the second RO stage 108 to generate at least the second brine stream 108A based on the supplied first brine stream 106A. In an embodiment, the apparatus 102 may be configured to control the second RO stage 108 to supply the second brine stream 108A to the third RO stage 120. In an embodiment, the apparatus 102 may be configured to control the second RO stage 108 to supply the second brine stream 108A to the third RO stage 120 without the use of the pressure pump. In an embodiment, the pressure pump may be used to supply the second brine stream 108A to the third RO stage 120 at the pre-determined pressure value. Details about the utilization of pressure pump for the supply of the second brine stream 108A to the third RO stage 120 are provided, in FIGS. 6A-6D.

Further, the apparatus 102 may be configured to control the third RO stage 120 to receive the second brine stream 108A. In an embodiment, the apparatus 102 may be configured to control the third RO stage 120 at a first time period, to generate at least the third brine stream 120A and the third brine stream 120A based on the supplied second brine stream 108A. For example, the apparatus 102 may be configured to control the third RO stage 120 at the first time period to generate the third brine stream 120A. In an embodiment, the apparatus 102 may be configured to control the third RO stage 120 to supply the generated third brine stream 120A to the energy recovery unit 110. In an embodiment, the second brine stream 108A may be supplied to the energy recovery unit through the pipeline without the use of the pressure pump.

In an embodiment, the apparatus 102 may be configured to control the energy recovery unit 110 to receive the third brine stream 120A from the third RO stage 120. In an embodiment, the third brine stream 120A may be received by the energy recovery unit 110 at, for example, but not limited to, a pressure say 40 bar. In an embodiment, the apparatus 102 may be configured to control the energy recovery unit 110 at a second time period to receive the liquid stream 116. The liquid stream 116 may be at the first pressure value P1. For example, the apparatus 102 may be configured to control the second RO stage 108 at the second time period to receive the liquid stream 116.

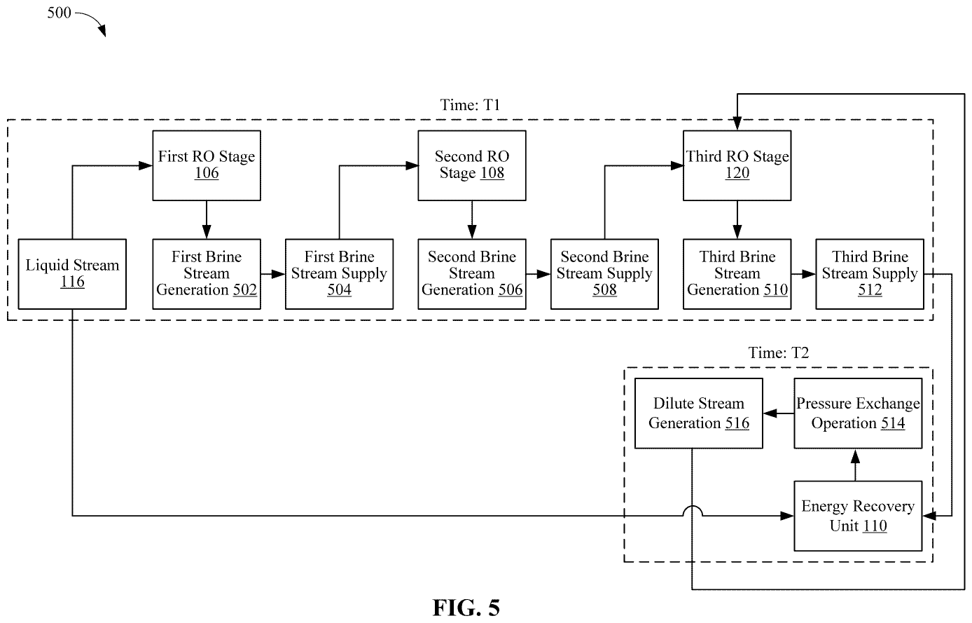

Furthermore, the apparatus 102 may be configured to control the energy recovery unit 110 to supply the liquid stream 116 to the third RO stage 120. The supplied liquid stream 116 may be at the second pressure value based on the received third brine stream 120A from the third RO stage 120. For example, the apparatus 102 may be configured to control the energy recovery unit 110 to supply the third brine stream 120A to the third RO stage 120 through the pipeline at the second pressure value using the pressure pump (say the pressure pump is configured to supply the third brine stream 120A to the third RO stage 120 at a pressure of 40 bar). Specifically, the apparatus 102 may be configured to capture the energy from the third brine stream 120A and transfer the captured energy to the liquid stream 116 at the second time period to increase the pressure of the liquid stream 116. Details about using the pressure pump to supply the liquid stream 116 at the second pressure value are provided, in FIGS. 6A-6D. Details about the liquid stream 116 supplied to the third RO stage 120 at the second pressure value are provided in FIG. 5.

In an embodiment, the liquid stream 116 from the energy recovery unit 110 and the second brine stream 108A from the second RO stage 108 may be mixed together to form the first diluted stream 122. The first diluted stream 122 may be further supplied to the third RO stage 120 (say through the pipeline). In another embodiment, the liquid stream 116 from the energy recovery unit 110 and the first brine stream 106A from the first RO stage 106 may be mixed together to form the first diluted stream 122. The first diluted stream 122 may be further supplied to the second RO stage 108 (say through the pipeline).

In an embodiment, the apparatus 102 may be configured to control the third RO stage 120 to receive the first diluted stream 122. The first diluted stream 122 may be a mixture of the second brine stream 108A and the liquid stream 116 received from the energy recovery unit 110. In an embodiment, the first diluted stream 122 may be a mixture of the first brine stream 106A and the liquid stream 116 from the energy recovery unit 110. In an embodiment, the apparatus 102 may be configured to control the third RO stage 120 to generate at least the third brine stream 120A and the third permeate stream 120B based on the first diluted stream 122.

Although in FIG. 1B, the apparatus 102 is shown as a separate entity from the RO plant 104, the disclosure is not so limited. Accordingly, in some embodiments, the apparatus 102 may be shown integrated within the RO plant 104, without deviation from the scope of the disclosure.

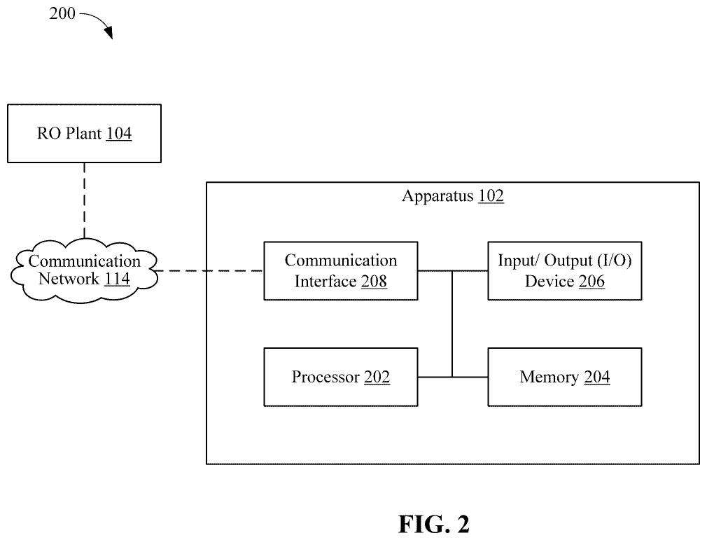

FIG. 2 illustrates a block diagram 200 of the apparatus 102 of FIG. 1A or FIG. 1B, in accordance with an embodiment of the disclosure. FIG. 2 is explained in conjunction with FIG. 1A and FIG. 1B. In FIG. 2 there is shown the block diagram 200 of the apparatus 102. The apparatus 102 may include at least one processor (referred to as a processor 202, hereinafter), at least one non-transitory memory (referred to as a memory 204, hereinafter), an input/output (I/O) device 206, a communication interface 208, a communication network 114, and the RO plant 104. The processor 202 may be connected to the memory 204, the I/O device 206, and the communication interface 208 through one or more wired or wireless connections. Although in FIG. 2, it is shown that the apparatus 102 includes the processor 202, the memory 204, the I/O device 206, and the communication interface 208. However, the disclosure may not be so limiting and the apparatus 102 may include fewer or more components to perform the same or other functions of the apparatus 102.

The processor 202 of the apparatus 102 may be configured to control the operations of the apparatus 102. In an embodiment, the processor 202 of the apparatus 102 may be configured to control the operations of, but not limited to, the first RO stage 106, the second RO stage 108, the energy recovery unit 110, and the third RO stage 120. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication interface 208 may provide an interface for accessing various features and data stored in the apparatus 102.

The memory 204 may be non-transitory and may include, for example, one or more volatile and/or non-volatile memories. In other words, for example, the memory 204 may be an electronic storage device (for example, a computer-readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplified in FIG. 1A and FIG. 1B, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In an embodiment, the memory 204 may include data such as pressure data associated with each of the liquid stream 116, the first brine stream 106A, the first permeate stream 106B, the second brine stream 108A, the second permeate stream 108B, the third brine stream 120A, the third permeate stream 120B, the diluted stream 118, and the first diluted stream 122. In an embodiment, the memory 204 may include the TDS values associated with each of the liquid stream 116, the first brine stream 106A, the first permeate stream 106B, the second brine stream 108A, the second permeate stream 108B, the third brine stream 120A, the third permeate stream 120B, the diluted stream 118, and the first diluted stream 122.

In some example embodiments, the I/O device 206 may communicate with the apparatus 102 and display the input and/or output of the apparatus 102. As such, the I/O device 206 may include a display and, in some embodiments, may also include a keyboard, a mouse, a touch screen, touch areas, soft keys, or other input/output mechanisms. In one embodiment, the apparatus 102 may include a user interface circuitry configured to control at least some functions of one or more I/O interface elements such as the display. The processor 202 and/or I/O device 206 circuitry including the processor 202 may be configured to control one or more functions of one or more I/O device 206 elements through computer program instructions (for example, software and/or firmware) stored on a memory 204 accessible to the processor 202.

The communication interface 208 may include the input interface and output interface for supporting communications to and from the apparatus 102 or any other component (such as the server 112) with which the apparatus 102 may communicate. The communication interface 208 may be any means such as a device or circuitry embodied in either hardware or a combination of hardware and software that is configured to receive and/or transmit data to/from a communications device in communication with the apparatus 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

In an embodiment, the communication network 114 may be one of the wired connections or the wireless connection. Examples of the communication network 114 may include, but are not limited to, the Internet, the cloud network, the Wireless Fidelity (Wi-Fi) network, the Personal Area Network (PAN), the Local Area Network (LAN), or the Metropolitan Area Network (MAN). Various devices in the block diagram 200 may be configured to connect to the communication network 114 in accordance with various wired and wireless communication protocols.

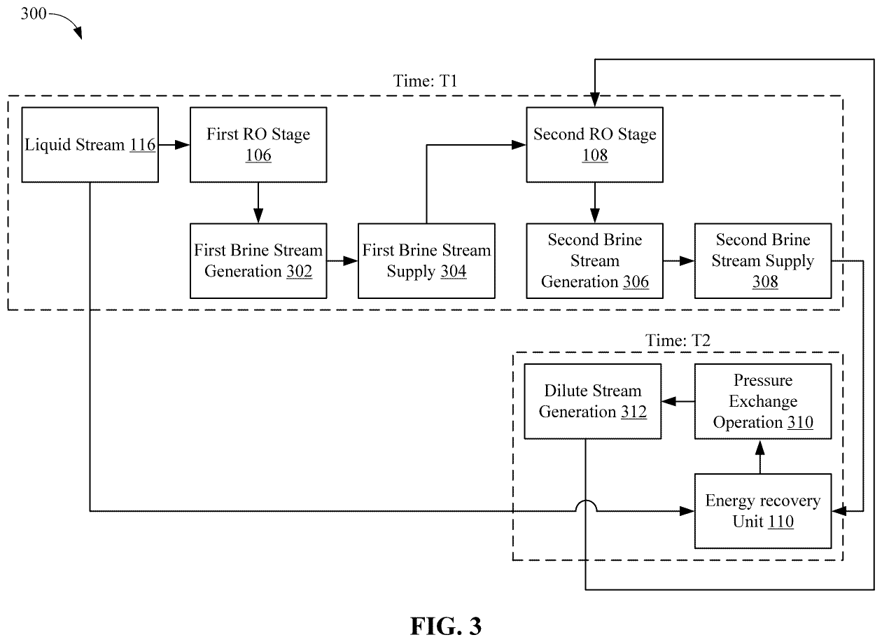

FIG. 3 illustrates exemplary operations for the two-stage RO with the interstage brine dilution, in accordance with an embodiment of the disclosure. FIG. 3 is explained in conjunction with elements from FIG. 1A, FIG. 1B, and FIG. 2. With reference to FIG. 3, there is shown a block diagram 300 that illustrates exemplary operations from 302 to 314, as described herein. The exemplary operations illustrated in the block diagram 300 may start at 302 and may be performed by any computing system, apparatus, or device, such as by the apparatus 102 of FIGS. 1A or 1B. Although illustrated with discrete blocks, the exemplary operations associated with one or more blocks of the block diagram 300 may be divided into additional blocks, combined into fewer blocks, or skipped, depending on the implementation.

At 302, a first brine stream generation operation. In the first brine stream generation operation, the apparatus 102 may be configured to control the first RO stage 106 to receive the liquid stream 116. The liquid stream 116 may be, but not limited to, the seawater, the brackish water, and the like. For example, the liquid stream 116 may be received through the pipeline from oceans, coastal lagoons, wetlands, and the like at the time ‘T1’. The apparatus 102 may be further configured to control the first RO stage 106 to execute the RO operation on the liquid stream 116. The RO operation may correspond to a water purification operation that may utilize the set of semi-permeable membranes to filter the impurities, the salts, and contaminants (such as lead, cadmium, pesticides, and the like) from the liquid stream 116 to generate the first permeate stream 106B). The semi-permeable membranes may include, by way of example and not by limitation, thin-film composite (TFC) membranes, and spiral-wound membranes. Details about the RO operation and semi-permeable membranes are known in the art and therefore have been omitted for the sake of brevity.

In an embodiment, the apparatus 102 may be configured to control the first RO stage 106 to generate the first brine stream 106A and the first permeate stream 106B based on the execution of the RO operation in the first RO stage. In an embodiment, a first total dissolved solids (TDS) value may be associated with the first permeate stream 106B, and the first brine stream 106A. The first TDS value may be indicative of a total concentration of dissolved elements associated with the corresponding stream and may be measured in by way of example, and not by limitation, milligrams per liter (mg/L). The dissolved elements may include inorganic salts (such as calcium, magnesium, potassium, and the like), organic matter, and the like. By way of example and not limitation, the first TDS value associated with the first brine stream 106A may be ‘50000’ mg/L.

At 304, a first brine stream supply operation may be executed. In the first brine stream supply operation, the apparatus 102 may be configured to control the first RO stage 106 to supply the first brine stream 106A to the second RO stage 108. For example, the first brine stream 106A may be supplied to the second RO stage 108 through the pipeline. The first brine stream 106A may be generated upon the execution of the RO operation on the liquid stream 116. For example, the first brine stream 106A supplied to the second RO stage 108 may be supplied at a 30 bar pressure value and the first TDS value associated with the first brine stream 106A may be ‘50000’ mg/L. In an embodiment, the apparatus 102 may be configured to control the first RO stage 106 to supply the first brine stream 106A to the second RO stage 108 without the use of a pressure pump. In an alternate embodiment, the pressure pump may be used to supply the first brine stream 106A to the second RO stage 108 so that the first brine stream 106A may be supplied to the second RO stage 108 at a pre-determined pressure value (say 50 bar). Details about the utilization of pressure pump for the supply of the first brine stream 106A to the second RO stage 108 are provided, in FIG. 4A.

At 306, a second brine stream generation operation may be executed. In the second brine stream generation operation, the apparatus 102 may be configured to control the second RO stage 108 to receive the first brine stream 106A from the first RO stage 106. The apparatus 102 may be further configured to control the second RO stage 108 to execute the RO operation on the first brine stream 106A to generate the second brine stream 108A and the second permeate stream 108B.

In an embodiment, the second permeate stream 108B may be stored in the permeate storage unit. In an embodiment, a second TDS value may be associated with the second permeate stream 108B. The second TDS value may be indicative of the total concentration of the dissolved elements in the second brine stream 108A. In an embodiment, the first TDS value associated with the first brine stream 106A may be less than the second TDS value associated with the second brine stream 108A. By way of an example and not limitation, the second TDS value associated with the second brine stream 108A may be ‘60000’ mg/L whereas the first TDS value associated with the first brine stream 106A may be ‘50000’ mg/L.

In an alternate embodiment, the second permeate stream 108B may be mixed with the first permeate stream 106B to generate the blended permeate stream. The blended permeate stream may be further supplied to the freshwater packaging unit and the like.

At 308, a second brine stream supply operation may be executed. In the second brine stream supply operation, the apparatus 102 may be configured to control the second RO stage 108 to supply the second brine stream 108A to the energy recovery unit 110 at the time ‘T1’. For example, the second brine stream 108A may be supplied to the energy recovery unit 110 through the pipeline, or the like at the time ‘T1’. The second brine stream 108A may be generated upon the execution of the RO operation on the first brine stream 106A that may be generated from the first RO stage 106. For example, the second brine stream 108A supplied to the energy recovery unit 110 may be supplied at a 35 bar pressure value. In an embodiment, the second brine stream 108A may be supplied to the energy recovery unit 110 through the pipeline without the use of the pressure pump.

At 310, a pressure exchange operation may be executed. In the pressure exchange operation, the apparatus 102 may be configured to control the energy recovery unit 110 to receive the liquid stream 116 at the first pressure value (say P1). In an embodiment, the liquid stream 116 may be received through the pipeline from the oceans, wetlands, and the like at a time ‘T2’. The apparatus 102 may be configured to supply the liquid stream 116 to the second RO stage 108 at the second pressure value, such that the second pressure value may be greater than the first pressure value. In an embodiment, the second brine stream 108A received from the second RO stage 108 may be utilized to elevate the pressure of the liquid stream 116 from the first pressure value to the second pressure value based on the exchange of pressure energy between the liquid stream 116 and the second brine stream 108A. For example, the liquid stream 116 may be received by the energy recovery unit 110 at the first pressure value. Further, the hydraulic energy of the second brine stream 108A may be utilized to elevate the pressure of the liquid stream 116 at the second pressure value.

The elevation of the pressure of the liquid stream 116 may be required to feed the liquid stream 116 to the second RO stage at a high-pressure value such that the liquid stream 116 may be filtered by the second RO stage 108. It may be noted that the TDS value of the liquid stream 116 may be high which may require the liquid stream 116 to be supplied to the second RO stage 108 at high pressure (say the second pressure value). The second pressure value associated with the liquid stream 116 may be required to pass the liquid stream 116 through a second set of semi-permeable membranes of the second RO stage 108. If the liquid stream 116 may be supplied to the second RO stage 108 at the first pressure value, then due to the presence of high TDS of the liquid stream 116, the liquid stream 116 may not pass the semi-permeable membranes. To overcome such problems, traditional pressure pumps were used to supply the liquid stream 116 to the second RO stage 108.

The pressure pumps may supply the liquid stream 116 to the second RO stage 108 to overcome osmotic pressure associated with the second RO stage 108. The osmotic pressure may be indicative of a minimum pressure at which the liquid stream 116 may be supplied to the second RO stage 108 to filter contaminants from the liquid stream 116. The pressure pumps may be further used to maintain a constant flow rate of the liquid stream 116 that may be supplied to the second RO stage 108. In case the liquid stream 116 may be supplied at a pressure less than the osmotic pressure associated with the second RO stage, the pressure pump may be used to elevate the pressure of the liquid stream 116 to supply the liquid stream 116 at a pressure greater than or equal to the osmotic pressure associated with the liquid stream 116 that may be supplied to the second RO stage 108. The energy from the second brine stream 108A may be used to elevate the pressure of the liquid stream 116. The utilization of the energy from the second brine stream 108A to supply the liquid stream 116 at the second pressure value may facilitate the supply of the liquid stream 116 to the second RO stage 108 without the use of the pressure pumps, thereby reducing the overall cost and energy consumption for the RO plant 104.

In an embodiment, hydraulic energy from the second brine stream 108A may be utilized to elevate the pressure of the liquid stream 116 from the first pressure value to the second pressure value. Based on the reception of the second brine stream 108A by the energy recovery unit 110, a movement may be caused in a first component associated with the energy recovery unit 110. The high pressure of the second brine stream 108A may be greater than the first pressure value associated with the liquid stream 116. In case the pressure of the second brine stream 108A may be less than the first pressure value, the energy recovery unit 110 may not be operable to supply the liquid stream 116 to the second RO stage 108.

In an embodiment, a momentum may be generated inside the energy recovery unit 110 upon the reception of the second brine stream 108A and the liquid stream 116 which may cause the rotation of the rotor. The rotation of the rotor may cause the transfer of hydraulic energy associated with the second brine stream 108A to the liquid stream 116. The transfer of the hydraulic energy associated with the second brine stream 108A may increase the pressure of the liquid stream 116 from the first pressure value to the second pressure value. As discussed above, the second pressure value may be greater than the first pressure value. The liquid stream 116 may be further supplied to the second RO stage 108 at the second pressure value upon the transfer of the hydraulic energy from the second brine stream 108A to the liquid stream 116.

At 312, a dilute stream generation operation may be executed. In the dilute stream generation operation, the apparatus 102 may be configured to generate the diluted stream 118. In an embodiment, the diluted stream 118 may be the mixture of the first brine stream 106A and the liquid stream 116. For example, the first brine stream 106A from the first RO stage 106 may be supplied to the second RO stage 108 through a first pipeline. Further, the liquid stream 116 may be supplied to the second RO stage 108 through a second pipeline. The first brine stream 106A and the liquid stream 116 may be blended together in the combined pipeline to generate the diluted stream 118. The diluted stream 118 may be associated with a TDS value such that the TDS value of the diluted stream 118 is greater than the TDS value associated with the liquid stream 116 and less than the TDS value associated with the first brine stream 106A.

In an embodiment, the apparatus 102 may be configured to control the second RO stage 108 to receive the diluted stream 118. For example, the diluted stream 118 may be received through the pipeline at the time ‘T2’. The apparatus 102 may be further configured to control the second RO stage 108 to execute the RO operation on the diluted stream 118 to generate at least the second brine stream 108A and the second permeate stream 108B.

The generation of the diluted stream 118 based on the first brine stream 106A from the first RO stage 106 and the liquid stream 116 from the energy recovery unit 110 is a continuous recirculating loop. The apparatus 102 may be configured to supply the second brine stream 108A (generated based on the diluted stream 118) to the energy recovery unit 110. The apparatus 102 further controls the energy recovery unit 110 to execute the pressure exchange operation between the liquid stream 116 and the second brine stream 108A. Upon the execution of the pressure exchange operation, the apparatus 102 further controls the energy recovery unit 110 to supply the liquid stream 116 to the second RO stage 108. The liquid stream is further blended with the first brine stream 106A to generate the diluted stream 118. The apparatus 102 controls the second RO stage 108 to generate at least the second brine stream 108A and the second permeate stream 108B based on the diluted stream 118.

In an embodiment, the second permeate stream 108B may be stored in the permeate storage unit. For example, the second permeate stream 108B may be supplied directly to the irrigation field, a water treatment plant, and the like. In an alternate embodiment, the second permeate stream 108B may be mixed with the first permeate stream 106B to generate the blended permeate stream. For example, the blended permeate stream may be stored in the permeate storage unit. For example, the blended permeate stream may be supplied directly to the water treatment plant, the freshwater packaging unit, and the like.

FIG. 4A is a diagram that illustrates an exemplary first implementation of apparatus for two-stage RO with the interstage brine dilution, in accordance with an embodiment of the disclosure. FIG. 4A is explained in conjunction with FIG. 1A, FIG. 1B, FIG. 2, and FIG. 3. With reference to FIG. 4A, there is shown an apparatus 400A for two-stage RO with the interstage brine dilution. The apparatus 400A includes a first pressure pump 404A, a second pressure pump 404B, a third pressure pump 404C, a first RO stage 406, a second RO stage 408, and an energy recovery unit 412.

At time T1, the apparatus 102 may be configured to control the first RO stage 406 to receive a liquid stream 402. The liquid stream 402 is an exemplary embodiment of the liquid stream 116 of the FIG. 1. The first RO stage 406 is an exemplary embodiment of the first RO stage 106 of the FIG. 1. The received liquid stream 402 may be supplied to the first RO stage 406 through a first pressure pump 404A. In an embodiment, the apparatus 102 may be configured to control the first pressure pump 404A to supply the liquid stream 402 to the first RO stage 406. The first pressure pump 404A may be a pump that may be used to maintain a pre-determined pressure of the liquid stream 402 that may be supplied to the first RO stage 406. For example, the apparatus 102 may be configured to control the first pressure pump 404A to supply the liquid stream 402 (say at a 10-bar pressure value). In an embodiment, the primary function of the first pressure pump 404A may be to increase the pressure of liquid stream 402. This may be required because the set of RO membranes in the first RO stage 406 may require a certain pressure to overcome osmotic pressure and effectively separate contaminants from liquid stream 402. The first pressure pump 404A may ensure that the water is delivered to the first RO stage 406 (or the first set of membranes in the first RO stage 406) at the appropriate pressure level.

In an embodiment, the apparatus 102 may be configured to control the first RO stage 406 to generate a first permeate stream 406A and a first brine stream 406B using the pressurized liquid stream 402. The first permeate stream 406A is an exemplary embodiment of the first permeate stream 106B of FIG. 1A or FIG. 1B and the first brine stream 406B is an exemplary embodiment of the first brine stream 106A of FIGS. 1A or 1B.

In an embodiment, the apparatus 102 may be configured to supply the first brine stream 406B to a second RO stage 408. The second RO stage 408 is an exemplary embodiment of the second RO stage 108 of FIG. 1A or FIG. 1B. In an embodiment, the first brine stream 406B may be supplied to the second RO stage 408 through a second pressure pump 404B. In an embodiment, the apparatus 102 may be configured to control the second pressure pump 404B to supply the first brine stream 406B associated with the first RO stage 406 to the second RO stage 408. In an embodiment, the primary function of the second pressure pump 404B may be to increase the pressure of the first brine stream 406B (for example from 10 psi to 12 psi). This may be required because the second set of RO membranes in the second RO stage 408 may require a certain pressure to overcome osmotic pressure and effectively separate contaminants from the first brine stream 406B.

In an embodiment, the apparatus 102 may be configured to control the second RO stage 408 to receive the first brine stream 406B. In an embodiment, the apparatus 102 may be configured to control the second RO stage 408 to generate a second permeate stream 408A and a second brine stream 408B using the first brine stream 406B. The second permeate stream 408A is an exemplary embodiment of the second permeate stream 108B of FIGS. 1A or 1B. The second brine stream 408B is an exemplary embodiment of the second brine stream 108A of FIGS. 1A or 1B.

In an embodiment, the apparatus 102 may be configured to control the second RO stage 408 to supply the second brine stream 408B to an energy recovery unit 412. The energy recovery unit 412 is an exemplary embodiment of the energy recovery unit 110 of FIGS. 1A or 1B. In an embodiment, the apparatus 102 may be configured to control the energy recovery unit 412 to receive the second brine stream 408B from the second RO stage 408. In an embodiment, the apparatus 102 may be configured to further control the energy recovery unit 412 to receive the liquid stream 402. In an embodiment, the apparatus 102 may be configured to control the energy recovery unit 412 to supply the liquid stream 402 to the second RO stage 408 at a second pressure value upon the execution of the operations on the liquid stream 402. Specifically, the energy recovery unit 412 may utilize the energy from the pressurized second brine stream 408B to elevate the pressure of the liquid stream 402B. This may help in saving energy required by a third pressure pump 404C to elevate the pressure of the liquid stream 116. Details about the execution of the operations associated with the energy recovery unit 412 on the liquid stream 402 are provided in FIG. 3. In an embodiment, the second brine stream 408B may be discarded from the energy recovery unit 412.

In an embodiment, the liquid stream 402 supplied from the energy recovery unit 412 to the second RO stage 408 may be supplied through the third pressure pump 404C. In an embodiment, the apparatus 102 may be configured to control the third pressure pump 404C to supply the liquid stream 402 to the second RO stage 408. The second pressure pump 404B may be a pump that may be used to maintain a pre-determined pressure of the liquid stream 402 that may be supplied to the second RO stage 408. For example, the pressure of the liquid stream 402 may be 10 psi. The energy recovery unit 412 may elevate the pressure of the liquid stream 402 from 10 psi to 12 psi by extracting and transferring the energy from the second brine stream 408B. However, if the pre-determined pressure of the liquid stream 402 that may be required for the second RO stage 408 is 20 psi, then the apparatus 102 may control the third pressure pump to elevate the pressure to 20 psi. Also, the elevation in the pressure from 10 psi to 12 psi may save energy as the energy requirement for elevating the pressure from 10 psi to 20 psi may be greater than the energy requirement for elevating the pressure from 12 psi to 20 psi.

At time T2, the apparatus 102 may be configured to control the second RO stage 408 to receive the first brine stream 406B from the first RO stage 406 and the liquid stream 402 from the energy recovery unit 412. The first brine stream 406B from the first RO stage 406 and the liquid stream 402 from the energy recovery unit 412 may be mixed to generate a diluted stream 414 (also referred to as a second diluted stream). In an embodiment, the apparatus 102 may be configured to control the second RO stage 408 to generate the second brine stream 408B and the second permeate stream 408A based on the diluted stream 414. In an embodiment, a blended permeate stream 410 may be generated based on the first permeate stream 406A, and the second permeate stream 408A. The blended permeate stream 410 may be the filtered water and may be used for downstream purposes as discussed above.

FIG. 4B is a diagram that illustrates an exemplary second implementation of apparatus for two-stage RO with the interstage brine dilution, in accordance with an embodiment of the disclosure. FIG. 4B is explained in conjunction with FIG. 1A, FIG. 1B, FIG. 2, FIG. 3, and FIG. 4A. With reference to FIG. 4B, there is shown an apparatus 400B for two-stage RO with the interstage brine dilution. Similar to FIG. 4A, the apparatus 400B includes the first pressure pump 404A, the third pressure pump 404C, the first RO stage 406, the second RO stage 408, and the energy recovery unit 412.

In an embodiment, the operations in FIG. 4B may be similar to the operations described in FIG. 4A, and therefore, the details of the operations associated with the apparatus 102 are provided in FIG. 4B is not provided for the sake of brevity. In an embodiment, the apparatus 102 may be configured to control the first RO stage 406 to supply the first brine stream 406B to the second RO stage 408. In the implementation of the apparatus described in FIG. 4A, the third pressure pump 404C may be used to supply the first brine stream 406B to the second RO stage 408 at the pre-determined pressure value. However, in FIG. 4B, in an embodiment, the apparatus 102 may be configured to control the first RO stage 406 to supply the first brine stream 406B to the second RO stage 408 at the pre-determined pressure associated with the first brine stream 406B without the use of the second pressure pump 404B.

FIG. 5 illustrates exemplary operations for the three-stage RO with the interstage brine dilution, in accordance with an embodiment of the disclosure. FIG. 5 is explained in conjunction with elements from FIG. 1A, FIG. 1B, FIG. 2, FIG. 3, FIG. 4A, and FIG. 4B. With reference to FIG. 5, there is shown a block diagram 500 that illustrates exemplary operations from 502 to 516, as described herein. The exemplary operations illustrated in the block diagram 500 may start at 502 and may be performed by any computing system, apparatus, or device, such as by the apparatus 102 of FIGS. 1A or 1B. Although illustrated with discrete blocks, the exemplary operations associated with one or more blocks of the block diagram 500 may be divided into additional blocks, combined into fewer blocks, or skipped, depending on the implementation.

At 502, the first brine stream generation operation may be executed. In the first brine stream generation operation, the apparatus 102 may be configured to control the first RO stage 106 to generate the first brine stream 106A and the first permeate stream 106B based on the liquid stream 116. Details about the generation of the first brine stream 106A and the first permeate stream 106B are provided, at 302, in FIG. 3.

At 504, the first brine stream supply operation may be executed. In the first brine stream supply operation, the apparatus 102 may be configured to control the first RO stage 106 to supply the first brine stream 106A to the second RO stage 108. Details about the supply of the first brine stream 106A to the second RO stage 108 are provided, at 304, in FIG. 3.

At 506, the second brine stream generation operation may be executed. In the second brine stream generation operation, the apparatus 102 may be configured to control the second RO stage 108 to receive the first brine stream 106A from the first RO stage 106. The second RO stage 108 may be further configured to generate the second brine stream 108A and the second permeate stream 108B based on the first brine stream 106A. Details about the generation of the second brine stream 108A and the second permeate stream 108B are provided, at 306, in FIG. 3.

At 508, the second brine stream supply operation may be executed. In the second brine stream supply operation, the apparatus 102 may be configured to control the second RO stage 108 to supply the second brine stream 108A to the third RO stage 120 at the time ‘T1’. For example, the second brine stream 108A may be supplied to the third RO stage 120 through the pipeline, or the like at the time ‘T1’. The second brine stream 108A may be generated upon the execution of the RO operation on the first brine stream 106A that may be generated from the first RO stage 106. For example, the second brine stream 108A is supplied to the third RO stage 120 (say at a 25 bar pressure value). In an embodiment, the second brine stream 108A may be supplied to the third RO stage 120 through the pipeline with/without the use of the pressure pump.

At 510, a third brine stream generation operation may be executed. In the third brine stream generation operation, the apparatus 102 may be configured to control the third RO stage 120 to receive the second brine stream 108A from the second RO stage 108. For example, the second brine stream 108A may be received through the pipeline at the time ‘T1’. The apparatus 102 may be further configured to control the third RO stage 120 to execute the RO operation on the second brine stream 108A to generate at least the third brine stream 120A and the third permeate stream 120B.

In an embodiment, the third permeate stream 120B may be stored in the permeate storage unit. For example, the third permeate stream 120B may be mixed with at least one of the first permeate stream 106B, or the second permeate stream 108B to generate the blended permeate stream. The blended permeate stream may be further supplied to the freshwater packaging unit and the like.

At 512, a third brine stream supply operation may be executed. In the third brine stream supply operation, the apparatus 102 may be configured to control the third RO stage 120 to supply the third brine stream 120A to the energy recovery unit 110 at the time ‘T1’. For example, the third brine stream 120A may be supplied to the energy recovery unit 110 through the pipeline, or the like at the time ‘T1’. The third brine stream 120A may be generated upon the execution of the RO operation on the second brine stream 108A that may be generated from the second RO stage 108. For example, the third brine stream 120A is supplied to the energy recovery unit 110 (say at a 40 bar pressure value). In an embodiment, the third brine stream 120A may be supplied to the energy recovery unit 110 through the pipeline without the use of the pressure pump.

At 514, the pressure exchange operation may be executed. In the pressure exchange operation, the apparatus 102 may be configured to control the energy recovery unit 110 to receive the liquid stream 116 at the first pressure value. In an embodiment, the liquid stream 116 may be received through the pipeline from the oceans, wetlands, and the like at a time ‘T2’. The apparatus 102 may be configured to supply the liquid stream 116 to the third RO stage 120 at the second pressure value, such that the second pressure value may be greater than the first pressure value. In an alternate embodiment, the liquid stream 116 may be supplied to the second RO stage 108.

In an embodiment, the third brine stream 120A received from the third RO stage 120 may be utilized to elevate the pressure of the liquid stream 116 from the first pressure value to the second pressure value. For example, the liquid stream 116 may be received by the energy recovery unit 110 at the first pressure value. Further, the hydraulic energy of the third brine stream 120A may be utilized to elevate the pressure of the liquid stream 116 at the second pressure value.

At 310, the pressure of liquid stream 116 may be elevated from the first pressure value to the second pressure value using the second brine stream 108A. While, at 514, the pressure of the liquid stream 116 may be elevated from the first pressure value to the second pressure value using the third brine stream 120A. Details about elevating the pressure of the liquid stream 116 are provided, at 310, in FIG. 3.

At 516, a dilute stream generation operation may be executed. In the dilute stream generation operation, the apparatus 102 may be configured to generate the first diluted stream 122. In an embodiment, the first diluted stream 122 may be the mixture of the second brine stream 108A and the liquid stream 116. For example, the second brine stream 108A from the second RO stage 108 may be supplied to the third RO stage 120 through a third pipeline. Further, the liquid stream 116 may be supplied to the third RO stage 120 through a fourth pipeline. In an embodiment, the second brine stream 108A and the liquid stream 116 may be blended together in the combined pipeline to generate the first diluted stream 122. The first diluted stream 122 may be associated with a first diluted TDS value such that the TDS value of the first diluted stream 122 may be greater than the TDS value associated with the liquid stream 116 and less than the TDS value associated with the second brine stream 108A.

The generation of the diluted stream 118 based on the second brine stream 108A from the second RO stage 108 and the liquid stream 116 from the energy recovery unit 110 is a continuous recirculating loop. The apparatus 102 may be configured to supply the third brine stream 120A (generated based on the first diluted stream 122) to the energy recovery unit 110. The apparatus 102 further controls the energy recovery unit 110 to execute the pressure exchange operation between the liquid stream 116 and the third brine stream 120A. Upon the execution of the pressure exchange operation, the apparatus 102 further controls the energy recovery unit 110 to supply the liquid stream 116 to the third RO stage 120. The liquid stream is further blended with the second brine stream 108A to generate the first diluted stream 122. The apparatus 102 controls the third RO stage 120 to generate at least the third brine stream 120A and the third permeate stream 120B based on the first diluted stream 122.

In an alternate embodiment, the first diluted stream 122 may be generated based on the first brine stream 106A from the first RO stage 106 and the liquid stream 116 from the energy recovery unit 110. In such an implementation, the first diluted stream 122 may be supplied as input to the second RO stage 108 for the generation of the second brine stream 108A, and the second brine stream 108A.

The generation of the first diluted stream 122 based on the first brine stream 106A from the first RO stage 106 and the liquid stream 116 from the energy recovery unit 110 is a continuous recirculating loop. The apparatus 102 may be configured to supply the third brine stream 120A (generated based on the second brine stream 108A) to the energy recovery unit 110. The apparatus 102 further controls the energy recovery unit 110 to execute the pressure exchange operation between the liquid stream 116 and the third brine stream 120A. Upon the execution of the pressure exchange operation, the apparatus 102 further controls the energy recovery unit 110 to supply the liquid stream 116 to the second RO stage 108. The liquid stream is further blended with the first brine stream 106A to generate the first diluted stream 122. The apparatus 102 controls the second RO stage 108 to generate at least the second brine stream 108A and the second permeate stream 108B based on the first diluted stream 122.

In an alternate embodiment, the apparatus 102 may be configured to control the third RO stage 120 to receive the first diluted stream 122. For example, the first diluted stream 122 may be received through the pipeline at the time ‘T2’. The apparatus 102 may be further configured to control the third RO stage 120 to execute the RO operation on the first diluted stream 122 to generate at least the third brine stream 120A and the third permeate stream 120B.

In an embodiment, the third permeate stream 120B may be stored in the permeate storage unit. For example, the third permeate stream 120B may be supplied directly to the irrigation field, a water treatment plant, and the like. In an embodiment, the third permeate stream 120B may be mixed with at least one of the first permeate stream 106B, or the second permeate stream 108B to generate the blended permeate stream. For example, the blended permeate stream may be stored in the permeate storage unit. For example, the blended permeate stream may be supplied directly to the water treatment plant, the freshwater packaging unit, and the like.

In an embodiment, the apparatus 102 may be configured to control the energy recovery unit 110 to supply the liquid stream 116 to the third RO stage 120. In an alternate embodiment, the apparatus 102 may be configured to control the energy recovery unit 110 to supply the liquid stream 116 to the second RO stage 108.

FIG. 6A is a diagram that illustrates an exemplary first implementation of apparatus for three-stage RO with the interstage brine dilution, in accordance with an embodiment of the disclosure. FIG. 6A is explained in conjunction with FIG. 1A, FIG. 1B, FIG. 2, FIG. 3, FIG. 4A, FIG. 4B, and FIG. 5. With reference to FIG. 6A, there is shown an apparatus 600A for three-stage RO with the interstage brine dilution. The apparatus 600A includes a first pressure pump 604A, a second pressure pump 604B, a third pressure pump 604C, a first RO stage 606, a second RO stage 608, a third RO stage 610, and an energy recovery unit 614.

At time T1, the apparatus 102 may be configured to control the first RO stage 606 to receive a liquid stream 602. The liquid stream 602 is an exemplary embodiment of the liquid stream 116 of the FIG. 1. The first RO stage 406 is an exemplary embodiment of the first RO stage 106 of FIG. 1. The received liquid stream 402 may be supplied to the first RO stage 406 through a first pressure pump 604A which may be an exemplary embodiment of the first pressure pump 404A. In an embodiment, the apparatus 102 may be configured to control the first pressure pump 604A to supply the liquid stream 602 to the first RO stage 606. The first pressure pump 604A may be a pump that may be used to maintain a pre-determined pressure of the liquid stream 602 that may be supplied to the first RO stage 606. For example, the apparatus 102 may be configured to control the first pressure pump 604A to supply the liquid stream 602 (say at the 10-bar pressure value). In an embodiment, the apparatus 102 may be configured to control the first RO stage 606 to generate a first permeate stream 606A and a first brine stream 606B using the liquid stream 602. The first permeate stream 606A is an exemplary embodiment of the first permeate stream 108B of FIGS. 1A or 1B. The first brine stream 606B is an exemplary embodiment of the first brine stream 106A of FIG. 1. In an embodiment, the apparatus 102 may be configured to supply the first brine stream 606B to a second RO stage 608. The second RO stage 608 is an exemplary embodiment of the second RO stage 108 of FIGS. 1A or 1B.

In an embodiment, the apparatus 102 may be configured to control the second RO stage 608 to receive the first brine stream 606B. In an embodiment, the apparatus 102 may be configured to control the second RO stage 608 to generate a second permeate stream 608A and a second brine stream 608B using the first brine stream 606B. The second permeate stream 408A is an exemplary embodiment of the second permeate stream 110B of FIGS. 1A or 1B. The second brine stream 408B is an exemplary embodiment of the second brine stream 110A of FIGS. 1A or 1B. In an embodiment, the apparatus 102 may be configured to control the second RO stage 608 to supply the second brine stream 608B to a third RO stage 610. The third RO stage 610 is an exemplary embodiment of the third RO stage 120 of FIGS. 1A or 1B. The received second brine stream 608B may be supplied to the third RO stage 610 through a second pressure pump 604B. In an embodiment, the apparatus 102 may be configured to control the second pressure pump 604B to elevate the pressure of the second brine stream 608B and supply the elevated second brine stream 608B to the third RO stage 610. The second pressure pump 604B may be a pump that may be used to maintain a pre-determined pressure of the second brine stream 608B that may be supplied to the third RO stage 610.

In an embodiment, the apparatus 102 may be configured to control the third RO stage 610 to receive the second brine stream 608B. In an embodiment, the apparatus 102 may be configured to control the third RO stage 610 to generate a third permeate stream 610A and a third brine stream 610B based on the second brine stream 608B. The third permeate stream 610A is an exemplary embodiment of the third permeate stream 120B of FIG. 1B. The third brine stream 610B is an exemplary embodiment of the third brine stream 120A FIG. 1B.

At a second time T2, the apparatus 102 may be configured to control the third RO stage 610 to supply the generated third brine stream 610B to the energy recovery unit 614. The energy recovery unit 614 is an exemplary embodiment of the energy recovery unit 110 of FIGS. 1A or 1B, or the energy recovery unit 412 of FIG. 4A or 4B.

In an embodiment, the apparatus 102 may be configured to control the third RO stage 610 to supply the third brine stream 610B to an energy recovery unit 614. In an embodiment, the apparatus 102 may be configured to control the energy recovery unit 614 to receive the third brine stream 610B from the third RO stage 610. In an embodiment, the apparatus 102 may be configured to further control the energy recovery unit 614 to receive the liquid stream 602. In an embodiment, the apparatus 102 may be configured to control the energy recovery unit 614 to supply the liquid stream 602 to the third RO stage 610 at the second pressure value upon the execution of the operations on the liquid stream 602. Details about the execution of the operations associated with the energy recovery unit 614 on the liquid stream 602 are provided in FIG. 3. In an embodiment, the third brine stream 610B may be discarded from the energy recovery unit 614 after the execution of the operations on the liquid stream 602.

In an embodiment, the liquid stream 602 supplied from the energy recovery unit 614 to the third RO stage 610 may be supplied through a third pressure pump 604C. In an embodiment, the apparatus 102 may be configured to control the third pressure pump 604C to supply the liquid stream 602 to the third RO stage 610. The third pressure pump 604C may be a pump that may be used to maintain a pre-determined pressure of the liquid stream 602 that may be supplied to the third RO stage 610.

In an embodiment, the apparatus 102 may be configured to control the third RO stage 610 to receive the second brine stream 608B from the second RO stage 608. The apparatus 102 may be configured to control the third RO stage 610 to receive the liquid stream 602 from the energy recovery unit 614. In an embodiment, the apparatus 102 may be configured to control the third RO stage 610 to generate the third brine stream 610B and the third permeate stream 610A based on a first diluted stream 616. The first diluted stream is an exemplary embodiment of the first diluted stream 122 of FIG. 1B. The first diluted stream 616 may be a mixture of the liquid stream 602 from the energy recovery unit 614 and the second brine stream 608B from the second RO stage 608. In an embodiment, a blended permeate stream 612 may be generated based on the first permeate stream 606A, the second permeate stream 608A, the third permeate stream 610A, or a combination thereof. The blended permeate stream 612 may be the filtered water.

FIG. 6B is a diagram that illustrates an exemplary second implementation of apparatus for three-stage RO with the interstage brine dilution, in accordance with an embodiment of the disclosure. FIG. 6B is explained in conjunction with FIG. 1A, FIG. 1B, FIG. 2, FIG. 3, FIG. 4A, FIG. 4B, FIG. 5, and FIG. 6A. With reference to FIG. 6B, there is shown an apparatus 600B for three-stage RO with the interstage brine dilution. The apparatus 600B includes a first pressure pump 604A, a second pressure pump 604B, a third pressure pump 604C, a fourth pressure pump 604D, a first RO stage 606, a second RO stage 608, a third RO stage 610, and an energy recovery unit 614.

In an embodiment, the apparatus 102 may be configured to control the first RO stage 606 to supply the first brine stream 606B to the second RO stage 608. As shown in FIG. 6A, the first brine stream 606B may be directly supplied to the second RO stage 608, and no intermediate pressure pump or the like may be required. In an alternate embodiment and as shown in FIG. 6B, the apparatus 102 may be configured to control the first RO stage 606 to supply the first brine stream 606B to the second RO stage 608 via the fourth pressure pump 604D. The fourth pressure pump 604D may be utilized to elevate the pressure of the first brine stream 606B.

FIG. 6C is a diagram that illustrates an exemplary third implementation of apparatus for three-stage RO with the interstage brine dilution, in accordance with an embodiment of the disclosure. FIG. 6C is explained in conjunction with FIG. 1A, FIG. 1B, FIG. 2, FIG. 3, FIG. 4A, FIG. 4B, FIG. 5, FIG. 6A, and FIG. 6B. With reference to FIG. 6C, there is shown an apparatus 600C for three-stage RO with the interstage brine dilution. The apparatus 600C includes the first pressure pump 604A, the second pressure pump 604B, the fourth pressure pump 604D, the first RO stage 606, the second RO stage 608, the third RO stage 610, and the energy recovery unit 614.

In FIG. 6C, the apparatus 600C may be configured to control the first RO stage 606 to receive the liquid stream 602. The received liquid stream 602 may be supplied to the first RO stage 606 through the first pressure pump 604A. In an embodiment, the apparatus 102 may be configured to control the first pressure pump 604A to supply the liquid stream 602 to the first RO stage 606. The apparatus 102 may be configured to control the first RO stage 606 to generate the first permeate stream 606A and the first brine stream 606B using the liquid stream 602. In an embodiment, the apparatus 102 may be configured to supply the first brine stream 606B to the second RO stage 608 through the fourth pressure pump 604D.

In an embodiment, the apparatus 102 may be configured to control the second RO stage 608 to receive the first brine stream 606B. In an embodiment, the apparatus 102 may be configured to control the second RO stage 608 to generate the second permeate stream 608A and the second brine stream 608B using the first brine stream 606B at the first time T1. In an embodiment, the apparatus 102 may be configured to control the second RO stage 608 to supply the second brine stream 608B to the third RO stage 610 via the second pressure pump 604B.

The apparatus 102 may be configured to control the third RO stage 610 to receive the second brine stream 608B. In an embodiment, the apparatus 102 may be configured to control the third RO stage 610 to generate the third permeate stream 610A and the third brine stream 610B based on the second brine stream 608B. In an embodiment, the apparatus 102 may be configured to control the third RO stage 610 to supply the generated third brine stream 610B to the energy recovery unit 614.

In an embodiment, the apparatus 102 may be configured to control the third RO stage 610 to supply the third brine stream 610B to the energy recovery unit 614 at the second time T2 after time T1. In an embodiment, the apparatus 102 may be configured to control the energy recovery unit 614 to receive the third brine stream 610B from the third RO stage 610. In an embodiment, the apparatus 102 may be configured to further control the energy recovery unit 614 to receive the liquid stream 602. In an embodiment, the apparatus 102 may be configured to control the energy recovery unit 614 to supply the liquid stream 602 to the second RO stage 608 at the second pressure value upon the execution of the operations on the liquid stream 602. Details about the execution of the operations associated with the energy recovery unit 614 on the liquid stream 602 are provided in FIG. 3. In an embodiment, the third brine stream 610B may be discarded from the energy recovery unit 614 after the execution of the operations on the liquid stream 602.

In an embodiment, the apparatus 102 may be configured to control the second RO stage 608 to receive the first brine stream 606B from the first RO stage 606. In an embodiment, the apparatus 102 may be configured to control the second RO stage 608 to receive the liquid stream 602 from the energy recovery unit 614. In an embodiment, the apparatus 102 may be configured to control the second RO stage 608 to generate the second brine stream 608B and the second permeate stream 608A based on the first diluted stream 616 at the second time T2. The first diluted stream 616 may be a mixture of the liquid stream 602 from the energy recovery unit 614 and the first brine stream 606B from the first RO stage 606.

Again, the apparatus 102 may be configured to control the second RO stage 608 to supply the second brine stream 608B to the third RO stage 610. The second brine stream 608B may be generated using the first diluted stream 122. In an embodiment, the apparatus 102 may be configured to control the third RO stage 610 to receive the second brine stream 608B from the second RO stage 608. In an embodiment, the apparatus 102 may be configured to control the third RO stage 610 to generate at least the third permeate stream 610A and the third brine stream 610B based on the received second brine stream 608B. In an embodiment, the blended permeate stream 612 may be generated based on the first permeate stream 606A, the second permeate stream 608A, the third permeate stream 610A, or a combination thereof. The blended permeate stream 612 may be the filtered water that may be used for downstream purposes.

FIG. 6D is a diagram that illustrates an exemplary fourth implementation of apparatus for three-stage RO with the interstage brine dilution, in accordance with an embodiment of the disclosure. FIG. 6D is explained in conjunction with FIG. 1A, FIG. 1B, FIG. 2, FIG. 3, FIG. 4A, FIG. 4B, FIG. 5, FIG. 6A, FIG. 6B, and FIG. 6C. With reference to FIG. 6D, there is shown an apparatus 600D for three-stage RO with the interstage brine dilution. The apparatus 600D includes the first pressure pump 604A, the second pressure pump 604B, the fourth pressure pump 604D, the first RO stage 606, the second RO stage 608, the third RO stage 610, and the energy recovery unit 614.

In an embodiment, the apparatus 102 may be configured to control the second RO stage 608 to supply the second brine stream 608B to the third RO stage 610. In FIG. 6C, the apparatus 102 may be configured to control the second RO stage 608 to supply the second brine stream 608B to the third RO stage 610 at the pre-determined pressure associated with the second brine stream 608B with the use of the second pressure pump 604B. In FIG. 6C, no pressure pump may be used to supply the second brine stream 608B to the third RO stage 610 at the pre-determined pressure value.

In an embodiment, the apparatus 102 may be configured to control the energy recovery unit 614 to supply the liquid stream 602 to the second RO stage 608. In FIG. 6C, no pressure pump or the like may be used to supply the liquid stream 602 to the second RO stage 608 at the pre-determined pressure value. While, in FIG. 6D, in an embodiment, the apparatus 102 may be configured to control the energy recovery unit 614 to supply the liquid stream 602 to the second RO stage 608 at the pre-determined pressure associated with the liquid stream 602 with the use of the third pressure pump 604C.

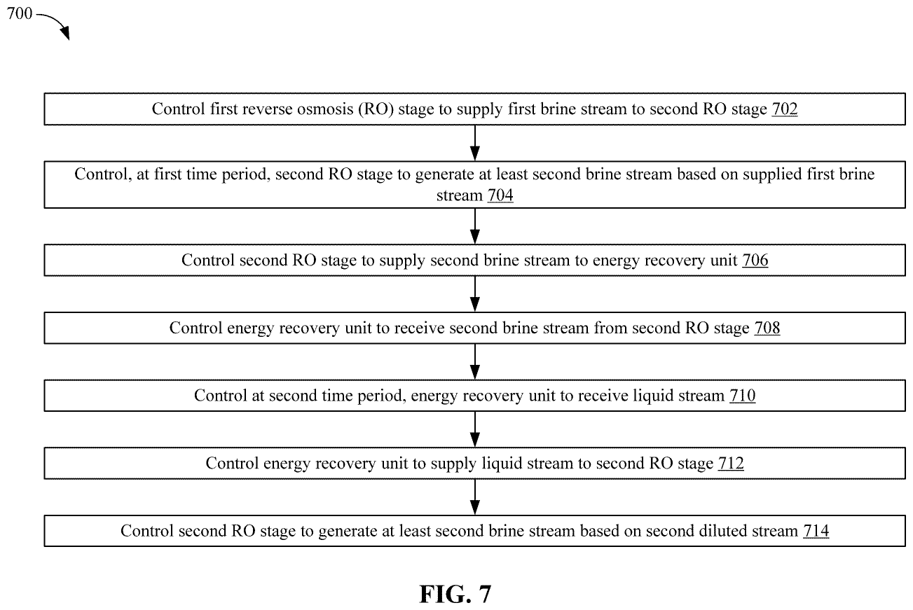

FIG. 7 is a flowchart 700 that illustrates an exemplary method for the two-stage RO with the interstage brine dilution, in accordance with an embodiment of the disclosure. FIG. 7 is explained in conjunction with elements from FIG. 1A, FIG. 1B, FIG. 2, FIG. 3, FIG. 4A, FIG. 4B, FIG. 5, FIG. 6A, FIG. 6B, FIG. 6C, and FIG. 6D. With reference to FIG. 7, there is shown the flowchart 700. The operations of the exemplary method may be executed by any computing system or an apparatus, for example, by the apparatus 102 of FIGS. 1A or 1B, or the processor 202 of FIG. 2. The operations of the flowchart 700 may start at 702.

At 702, the first RO stage 106 may be controlled to supply the first brine stream 106A to the second RO stage 108. In an embodiment, the apparatus 102 may be configured to control the first RO stage 106 to supply the first brine stream 106A to the second RO stage 108. Details about controlling the first RO stage 106 to supply the first brine stream 106A to the second RO stage 108 are provided, for example, in FIG. 3.

At 704, the second RO stage 108 may be controlled at the first time period to generate at least the second brine stream 108A based on the supplied first brine stream 106A. In an embodiment, the apparatus 102 may be configured to control, at the first time period, the second RO stage 108 to generate at least the second brine stream 108A based on the supplied first brine stream 106A. Details about controlling the second RO stage 108 at the first time period to generate at least the second brine stream 108A are provided, for example, in FIG. 3.

At 706, the second RO stage 108 may be controlled to supply the second brine stream 108A to the energy recovery unit 110. In an embodiment, the apparatus 102 may be configured to control the second RO stage 108 to supply the second brine stream 108A to the energy recovery unit 110. Details about controlling the second RO stage 108 to supply the second brine stream 108A to the energy recovery unit 110 are provided, for example, in FIG. 3.

At 708, the energy recovery unit 110 may be controlled to receive the second brine stream 108A from the second RO stage 108. In an embodiment, the apparatus 102 may be configured to control the energy recovery unit 110 to receive the second brine stream 108A from the second RO stage 108. Details about controlling the energy recovery unit 110 to receive the second brine stream 108A from the second RO stage 108 are provided, for example, in FIG. 3.

At 710, the energy recovery unit 110 may be controlled at the second time period to receive the liquid stream 116. In an embodiment, the apparatus 102 may be configured to control the energy recovery unit 110 at the second time period to receive the liquid stream 116. Details about controlling the energy recovery unit 110 to receive the liquid stream 116 are provided, for example, in FIG. 3.

At 712, the energy recovery unit 110 may be controlled to supply the liquid stream 116 to the second RO stage 108. In an embodiment, the apparatus 102 may be configured to control the energy recovery unit 110 to supply the liquid stream 116 to the second RO stage 108. Details about controlling the energy recovery unit 110 to supply the liquid stream 116 to the second RO stage 108 are provided, for example, in FIG. 3.

At 714, the second RO stage 108 may be controlled to generate at least the second brine stream 108A based on the diluted stream 118. In an embodiment, the apparatus 102 may be configured to control to generate at least the second brine stream 108A based on the diluted stream 118. Details about controlling the second RO stage 108 to generate at least the second brine stream 108A are provided, for example, in FIG. 3.

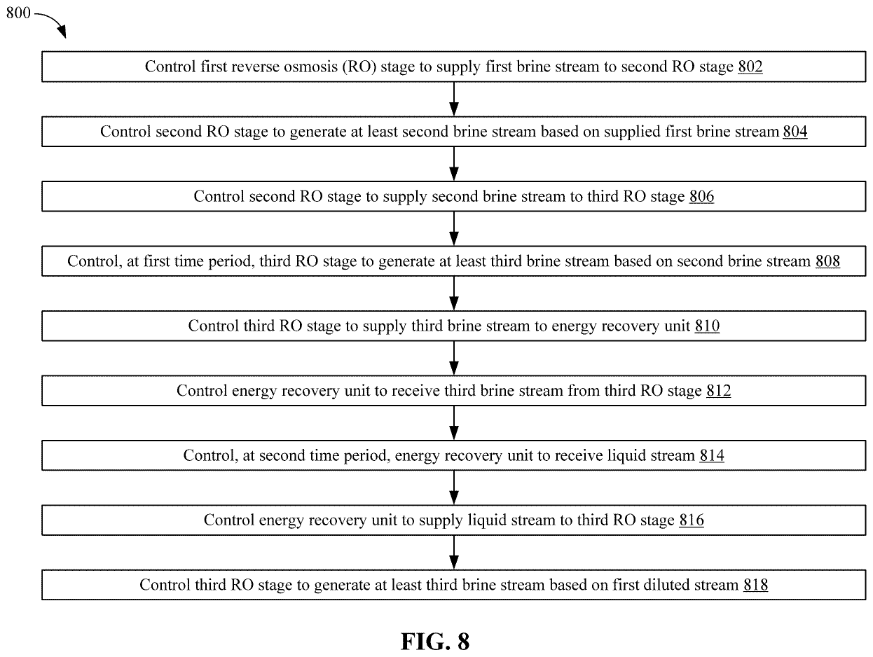

FIG. 8 is a flowchart 800 that illustrates an exemplary method for the three-stage RO with the interstage brine dilution, in accordance with an embodiment of the disclosure. FIG. 8 is explained in conjunction with elements from FIG. 1A, FIG. 1B, FIG. 2, FIG. 3, FIG. 4A, FIG. 4B, FIG. 5, FIG. 6A, FIG. 6B, FIG. 6C, FIG. 6D, and FIG. 7. With reference to FIG. 8, there is shown the flowchart 800. The operations of the exemplary method may be executed by any computing system or an apparatus, for example, by the apparatus 102 of FIGS. 1A or 1B, or the processor 202 of FIG. 2. The operations of the flowchart 800 may start at 802.

At 802, the first RO stage 106 may be controlled to supply the first brine stream 106A to the second RO stage 108. In an embodiment, the apparatus 102 may be configured to control the first RO stage 106 to supply the first brine stream 106A to the second RO stage 108. Details about controlling the first RO stage 106 to supply the first brine stream 106A to the second RO stage 108 are provided, for example, in FIG. 5.

At 804, the second RO stage 108 may be controlled to generate at least the second brine stream 108A based on the supplied first brine stream 106A. In an embodiment, the apparatus 102 may be configured to control the second RO stage 108 to generate at least the second brine stream 108A based on the supplied first brine stream 106A. Details about controlling the second RO stage 108 to generate at least the second brine stream 108A are provided, for example, in FIG. 5.

At 806, the second RO stage 108 may be controlled to supply the second brine stream 108A to the third RO stage 120. In an embodiment, the apparatus 102 may be configured to control the second RO stage 108 to supply the second brine stream 108A to the third RO stage 120. Details about controlling the second RO stage 108 to supply the second brine stream 108A to the third RO stage 120 are provided, for example, in FIG. 5.

At 808, the third RO stage 120 may be controlled at the first time period to generate at least the third brine stream 120A based on the second brine stream 108A. In an embodiment, the apparatus 102 may be configured to control the third RO stage 120 at the first time period to generate at least the third brine stream 120A based on the second brine stream 108A. Details about controlling the third RO stage 120 at the first time period to generate at least the third brine stream 120A are provided, for example, in FIG. 5.

At 810, the third RO stage 120 may be controlled to supply the third brine stream 120A to the energy recovery unit 110. In an embodiment, the apparatus 102 may be configured to control the third RO stage 120 to supply the third brine stream 120A to the energy recovery unit 110. Details about controlling the third RO stage 120 to supply the third brine stream 120A to the energy recovery unit 110 are provided, for example, in FIG. 5.

At 812, the energy recovery unit 110 may be controlled to receive the third brine stream 120A from the third RO stage 120. In an embodiment, the apparatus 102 may be configured to control the energy recovery unit 110 to receive the third brine stream 120A from the third RO stage 120. Details about controlling the energy recovery unit 110 to receive the third brine stream 120A from the third RO stage 120 are provided, for example, in FIG. 5.

At 814, the energy recovery unit 110 may be controlled at the second time period to receive the liquid stream 116. In an embodiment, the apparatus 102 may be configured to control the energy recovery unit 110 at the second time period to receive the liquid stream 116. Details about controlling the energy recovery unit 110 at the second time period to receive the liquid stream 116 are provided, for example, in FIG. 5.

At 816, the energy recovery unit 110 may be controlled to supply the liquid stream 116 to the third RO stage 120. In an embodiment, the apparatus 102 may be configured to control the energy recovery unit 110 to supply the liquid stream 116 to the third RO stage 120. Details about controlling the energy recovery unit 110 to supply the liquid stream 116 to the third RO stage 120 are provided, for example, in FIG. 5.

At 818, the third RO stage 120 may be controlled to generate at least the third brine stream 120A based on the first diluted stream 122. In an embodiment, the apparatus 102 may be configured to control the third RO stage 120 to generate at least the third brine stream 120A based on the first diluted stream 122. Details about controlling the third RO stage 120 to generate at least the third brine stream 120A are provided, for example, in FIG. 5.

Accordingly, blocks of the flowcharts 700 and 800 support combinations of means for performing the specified functions and combinations of operations for performing the specified functions. It will also be understood that one or more blocks of the flowchart 700, and the flowchart 800 can be implemented by special-purpose hardware-based computer systems which perform the specified functions, or combinations of special-purpose hardware and computer instructions.

Alternatively, the apparatus 102 may comprise means for performing each of the operations described above. In this regard, according to an example embodiment, examples of means for performing operations may comprise, for example, the processor 202 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. An apparatus for reverse osmosis, comprising:
one or more processors configured to:
control a first reverse osmosis (RO) stage to supply a first brine stream to a second RO stage;
control the second RO stage to generate at least a second brine stream based on the supplied first brine stream;
control the second RO stage to supply the second brine stream to a third RO stage;
control, at a first time period, the third RO stage to generate at least a third brine stream based on the second brine stream;
control the third RO stage to supply the third brine stream to an energy recovery unit;
control the energy recovery unit to receive the third brine stream from the third RO stage;
control, at a second time period, the energy recovery unit to receive a liquid stream, wherein the liquid stream is at a first pressure value, and wherein the liquid stream corresponds to at least a seawater;
control the energy recovery unit to supply the liquid stream to the third RO stage, wherein the supplied liquid stream is supplied at a second pressure value based on the third brine stream from the third RO stage; and
control the third RO stage to generate at least the third brine stream based on a first diluted stream, wherein the first diluted stream corresponds to a mixture of the second brine stream and the liquid stream.

2. The apparatus of claim 1, wherein the one or more processors are further configured to:
control the energy recovery unit to supply the liquid stream to the second RO stage, wherein the liquid stream is supplied at the second pressure value based on the third brine stream from the third RO stage; and
control the second RO stage to generate at least the second brine stream based on a second diluted stream, wherein the second diluted stream corresponds to a mixture of the first brine stream and the liquid stream from the energy recovery unit.

3. The apparatus of claim 2, wherein the one or more processors are further configured to:
control the energy recovery unit to supply the liquid stream to the second RO stage, wherein the supplied liquid stream is supplied at the second pressure value based on the second brine stream from the second RO stage; and
control the second RO stage to generate at least the second brine stream based on the second diluted stream.

4. The apparatus of claim 1, wherein the one or more processors are further configured to:
control the first RO stage to execute an RO operation on the liquid stream; and
control the first RO stage to generate at least a first permeate stream and the first brine stream upon the execution of the RO operation on the liquid stream.

5. The apparatus of claim 4, wherein the one or more processors are further configured to:
control the second RO stage to execute the RO operation on the first brine stream; and
control the second RO stage to generate at least a second permeate stream and the second brine stream upon the execution of the RO operation.

6. The apparatus of claim 5, wherein the one or more processors are further configured to:
control the third RO stage to execute the RO operation on the first diluted stream; and
control the third RO stage to generate at least a third permeate stream and the third brine stream upon the execution of the RO operation.

7. The apparatus of claim 6, wherein the one or more processors are further configured to:
control the supply of at least one of the first permeate stream, the second permeate stream, and the third permeate stream to generate a blended permeate stream.

8. The apparatus of claim 1, wherein a first total dissolved solids (TDS) value associated with the first brine stream is less than a second TDS value associated with the second brine stream.

9. A method, comprising:
controlling a first reverse osmosis (RO) stage to supply a first brine stream to a second RO stage;
controlling the second RO stage to generate at least a second brine stream based on the supplied first brine stream;
controlling the second RO stage to supply the second brine stream to a third RO stage;
controlling, at a first time period, the third RO stage to generate at least a third brine stream based on the second brine stream;
controlling the third RO stage to supply the third brine stream to an energy recovery unit;
controlling the energy recovery unit to receive the third brine stream from the third RO stage;
controlling, at a second time period, the energy recovery unit to receive a liquid stream, wherein the liquid stream is at a first pressure value, and wherein the liquid stream corresponds to at least a seawater;
controlling the energy recovery unit to supply the liquid stream to the third RO stage, wherein the supplied liquid stream is supplied at a second pressure value based on the third brine stream from the third RO stage; and
controlling the third RO stage to generate at least the third brine stream based on a first diluted stream, wherein the first diluted stream corresponds to a mixture of the second brine stream and the liquid stream.

10. The method of claim 9, wherein the method further comprising:
controlling the energy recovery unit to supply the liquid stream to the second RO stage, wherein the liquid stream is supplied at the second pressure value based on the third brine stream from the third RO stage; and
controlling the second RO stage to generate at least the second brine stream based on a second diluted stream, wherein the second diluted stream corresponds to a mixture of the first brine stream and the liquid stream from the energy recovery unit.

11. The method of claim 10, wherein the method further comprising:
controlling the energy recovery unit to supply the liquid stream to the second RO stage, wherein the supplied liquid stream is supplied at the second pressure value based on the second brine stream from the second RO stage; and
controlling the second RO stage to generate at least the second brine stream based on the second diluted stream.

12. The method of claim 9, wherein the method further comprising:
controlling the first RO stage to execute an RO operation on the liquid stream; and
controlling the first RO stage to generate at least a first permeate stream and the first brine stream upon the execution of the RO operation on the liquid stream.

13. The method of claim 12, wherein the method further comprising:
controlling the second RO stage to execute the RO operation on the first brine stream; and
controlling the second RO stage to generate at least a second permeate stream and the second brine stream upon the execution of the RO operation.

14. The method of claim 13, wherein the method further comprising:
controlling the third RO stage to execute the RO operation on the first diluted stream; and
controlling the third RO stage to generate at least a third permeate stream and the third brine stream upon the execution of the RO operation.

15. The method of claim 14, wherein the method further comprising:
controlling the supply of at least one of the first permeate stream, the second permeate stream, and the third permeate stream to generate a blended permeate stream.

16. The method of claim 9, wherein a first total dissolved solids (TDS) value associated with the first brine stream is less than a second TDS value associated with the second brine stream.

17. An apparatus for reverse osmosis, comprising:
one or more processors configured to:
control a first reverse osmosis (RO) stage to supply a first brine stream to a second RO stage;
control, at a first time period, the second RO stage to generate at least a second brine stream based on the supplied first brine stream;
control the second RO stage to supply the second brine stream to an energy recovery unit;
control the energy recovery unit to receive the second brine stream from the second RO stage;
control, at a second time period, the energy recovery unit to receive a liquid stream, wherein the liquid stream is at a first pressure value, and wherein the liquid stream corresponds to at least a seawater;
control the energy recovery unit to supply the liquid stream to the second RO stage, wherein the supplied liquid stream is supplied at a second pressure value based on the second brine stream from the second RO stage; and
control the second RO stage to generate at least the second brine stream based on a second diluted stream, wherein the second diluted stream corresponds to a mixture of the first brine stream and the liquid stream.

18. The apparatus of claim 17, wherein the one or more processors are further configured to:
control the energy recovery unit to supply the liquid stream to the second RO stage, wherein the liquid stream is supplied at the second pressure value based on the second brine stream from the second RO stage; and
control the second RO stage to generate at least the second brine stream based on a second diluted stream, wherein the second diluted stream corresponds to a mixture of the first brine stream and the liquid stream from the energy recovery unit.

19. The apparatus of claim 18, wherein the one or more processors are further configured to:
control the energy recovery unit to supply the liquid stream to the second RO stage, wherein the supplied liquid stream is supplied at the second pressure value based on the second brine stream from the second RO stage; and
control the second RO stage to generate at least the second brine stream based on the second diluted stream.

20. The apparatus of claim 17, wherein a first total dissolved solids (TDS) value associated with the first brine stream is less than a second TDS value associated with the second brine stream.
